(19) United States
(12) Patent Application Publication
(10) Pub. No.: US 2025/0280032 A1
(43) Pub. Date: Sep. 4, 2025

(54) THREAT DETECTION AND REMEDIATION

(71) Applicant: Box, Inc., Redwood City, CA (US)

(72) Inventors: Rohit Bakshi, Campbell, CA (US); Matteo Taddei, Amsterdam (NL)

(73) Assignee: Box, Inc., Redwood City, CA (US)

(21) Appl. No.: 18/592,430

(22) Filed: Feb. 29, 2024

(51) Int. Cl. H04L 9/40

(52) U.S. Cl. CPC H04L 63/1441

(57) ABSTRACT

Methods, systems, and computer program products for malevolent intent detection. Multiple cloud-based computer components are operatively interconnected to carry out operations for malevolent intent detection and remediation. In operation, a content management system (CMS) collects collaboration activities over time and over a content object so as to form a historical record of collaborator activities that includes a time-wise tracking of collaboration events over the content object. The CMS is interfaced with an electronic signature system (ESS) that captures e-signing events at the electronic signature system. Operational modules are invoked so as to recognize an occurrences of an e-signing event, and thereafter to perform a risk analysis of the e-signing event using both (a) portions of the historical record of collaborator activities for the content object at the CMS and (b) any information from an interaction with the ESS. Recommended remediation actions are emitted based on results of the risk analysis.

### TECHNICAL FIELD

This disclosure relates to malevolent behavior detection, and more particularly to techniques for real time threat detection and remediation.

### BACKGROUND

Electronic signature systems (“e-signature systems” or “e-sig systems” or “ESS”) have become ubiquitous-nearly fully replacing the now archaic practice of printing, signing in hand-and-ink, and scanning or mailing the signed document to recipients. The practice of ‘routing’ a paper document from person to person or from desk to desk, or from office to office or from site to site has now been almost completely obsoleted. This is because there are now sufficient technological mechanisms in place that implement at least rudimentary signatory authentication, envelope routing, and distribution of e-signed documents.

Some of these electronic signature systems have become sufficiently feature-enabled and flexible that e-signature systems are now being used to authenticate and track ongoing revisions to a document (e.g., a negotiation history of a contract) that is intended to be finalized and then signed by multiple parties. Such features, together with various technological advances that underly e-signing systems, have resulted in the ability to track every event (e.g., any/all e-signature events, every document modification, every workflow gate, every authentication, every comment, every transmission, every representation, etc.).

While tracking every e-signature event, every document modification, every workflow gate, every authentication, every comment, every transmission, every representation, etc. leads to better collaboration over these to-be-signed documents, it also leads to availability of more and more information being presented (e.g., in metadata, in a user interface display, etc.), which in turn leads to an increased likelihood value that a malefactor (e.g., a rogue employee) will be able to exploit vulnerabilities based on the additional information becoming available to the malefactor.

Unfortunately, even as more and more information becomes accessible/exploitable (e.g., from the wealth of information that derives from computer-implemented content management systems) legacy computer information usage safeguards implemented in—or in conjunction with—security profiles when using electronic signature systems have failed to keep pace with the ever-increasing risks introduced by the availability of additional computer-generated information. To address this deficiency as it applies to legacy electronic signature systems and/or to address this deficiency as it applies to legacy content management systems, the herein-provided description and figures disclose technologies needed to thwart a malefactor's attempts to exploit the foregoing vulnerabilities.

The problem to be solved is therefore rooted in various technological limitations of legacy approaches. Improved technologies are needed. In particular, improved applications of technologies are needed to address the aforementioned technological limitations of legacy approaches.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and computer program products for real time threat detection and remediation, which techniques advance the relevant technologies to address technological issues with legacy approaches. More specifically, the present disclosure describes techniques used in systems, methods, and in computer program products for real-time identification of suspicious activities during e-sign processing. Certain embodiments are directed to technological solutions for combining threat-predictive information from an electronic signature system with threat-predictive information from a content management system.

The disclosed embodiments modify and improve beyond legacy approaches. In particular, the herein-disclosed techniques provide technical solutions that address the technical problems attendant to legacy fraud detection techniques are far too imprecise. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

For example, when performing computer operations that address the various technical problems underlying legacy fraud detection, both memory usage and CPU cycles demanded are significantly reduced as compared to the memory usage and CPU cycles that would be needed but for practice of the herein-disclosed techniques. Strictly as one example, the data structures as disclosed herein and their use serve to reduce both memory usage and CPU cycles as compared to alternative approaches. Moreover, information that is received during operation of the embodiments is transformed by the processes that store data into and retrieve data from the aforementioned data structures.

The ordered combination of steps of the embodiments serve in the context of practical applications that perform steps that combine threat-predictive information from an electronic signature system with threat-predictive information from a content management system. This is more efficient for the computer at least by virtue of early detection of threats, which early detection of threats and corresponding early remediation avoids large amounts of computer processing that would be expended on remediation but for practice of the herein-disclosed techniques. These techniques for combining threat-predictive information from an electronic signature system with threat-predictive information from a content management system overcome long-standing yet heretofore unsolved technological problems associated with legacy fraud detection techniques.

Many of the herein-disclosed embodiments for combining threat-predictive information from an electronic signature system with threat-predictive information from a content management system are technological solutions pertaining to technological problems that arise in the hardware and software arts that underlie content management systems. Aspects of the present disclosure achieve performance and other improvements in peripheral technical fields including, but not limited to, fraud forensics and machine learning for fraud detection.

Some embodiments include a sequence of instructions that are stored on a non-transitory computer readable medium. Such a sequence of instructions, when stored in memory and executed by one or more processors, causes the one or more processors to perform a set of acts for combining threat-predictive information from an electronic signature system with threat-predictive information from a content management system.

Some embodiments include the aforementioned sequence of instructions that are stored in a memory, which memory is interfaced to one or more processors such that the one or more processors can execute the sequence of instructions to cause the one or more processors to implement acts for combining threat-predictive information from an electronic signature system with threat-predictive information from a content management system.

In various embodiments, any combinations of any of the above can be organized to perform any variation of acts for real-time identification of suspicious activities during e-sign processing, and many such combinations of aspects of the above elements are contemplated.

Further details of aspects, objectives and advantages of the technological embodiments are described herein and in the figures and claims.

### BRIEF DESCRIPTION OF THE DRAWINGS

The drawings described below are for illustration purposes only. The drawings are not intended to limit the scope of the present disclosure.

FIG. 1A1 exemplifies a threat prediction system that is configured for real-time identification of suspicious activities during e-sign processing, according to an embodiment.

FIG. 1A2 shows a multi-token state machine that is configured for use in systems that provide real-time identification of suspicious activities during e-sign processing, according to an embodiment.

FIG. 1A3 depicts a multi-epoch feature vector gathering technique that is configured for use in systems that provide real-time identification of suspicious activities during e-sign processing, according to an embodiment.

FIG. 1A4 depicts a risk score representation that is configured for use in systems that provide real-time identification of suspicious activities during e-sign processing, according to an embodiment.

FIG. 1A5 depicts an event-aware risk scoring function that combines parameters drawn from both an electronic signature system and a content management system, according to an embodiment.

FIG. 1B1 depicts a sampling of electronic signature system threat handling scenarios, according to an embodiment.

FIG. 1B2 depicts a sampling of content management system threat handling scenarios, according to an embodiment.

FIG. 1C exemplifies a threat remediation system that initiates remediation actions based on deemed suspicious activities that are identified during e-sign processing, according to an embodiment.

FIG. 2 presents a flowchart depicting certain operations of a suspicious activity remediation system, according to an embodiment.

FIG. 3A exemplifies an API-based architecture, according to an embodiment.

FIG. 3B exemplifies a bidirectional data-enriching architecture, according to an embodiment.

FIG. 3C exemplifies a unified bidirectional data-enriching architecture, according to an embodiment.

FIG. 4 is a flowchart depicting a remediation model generation system, according to an embodiment.

FIG. 5A depicts an example user interface for defining remediation rules, according to an embodiment.

FIG. 5B depicts an example rule triggering technique as used in systems for real-time identification of suspicious activities during e-sign processing, according to an embodiment.

FIG. 6A depicts an example multisystem integration technique that is configured for real-time identification of suspicious activities during e-sign processing, according to an embodiment.

FIG. 6B depicts an example organization of highly-enriched graph data, according to an embodiment.

FIG. 7A, FIG. 7B and FIG. 7C present block diagrams of computing architectures having components suitable for implementing embodiments of the present disclosure and/or for use in the herein-described environments.

### DETAILED DESCRIPTION

Aspects of the present disclosure solve problems associated with using computer systems for legacy fraud detection techniques. These problems are unique to, and may have been created by, various computer-implemented methods for legacy fraud detection techniques that are far too imprecise and/or unaware. Some embodiments are directed to approaches for combining threat-predictive information from an electronic signature system with threat-predictive information from a content management system. The accompanying figures and discussions herein present example environments, systems, methods, and computer program products for real-time identification of at least potentially suspicious activities during e-signature processing.

### OVERVIEW

Fortunately, there is a wealth of information that derives from computer-implemented content management systems (e.g., content objects, content object metadata, user behavior, collaboration activity events, etc.). Even more fortunately, electronic e-signature systems (ESSs) are now being configured to support integration into or with content management systems (CMSs) in a manner that facilitates combining information from both the subject ESS as well as a subject CMS so as to address both (1) implementation of a much wider range of heuristics, and/or prediction models as well as (2) implementing much more precise variations of the aforementioned computerized safeguards, and/or early warnings. Even still more fortunately, modern CMS systems have richly informed logs of CMS (and other) events that reach back into history. Analysis of such richly informed logs makes it possible to pinpoint forensically-important historical information (e.g., aggregated information pertaining to a document that is, or is related to, a document being subjected to an ESS flow) that can in turn be used with then current events that take place in real time during operation of the ESS.

Accordingly, disclosed herein are techniques for combining information from an electronic signature system with information from a content management system. At any point in time throughout the progression of an e-signing process, information from both systems are advantageously combined and used in a predictive model such that early warnings of potentially malicious behaviors can be addressed, possibly resulting in the thwarting of further potentially malicious behaviors. Strictly as one example, information taken from observations of events a specific user's progression through a series of events/states might be captured in real time and then compared to a previously captured series of events/states that had occurred and been captured prior to a known data loss or other malicious event. If the observed user progression through that user's particular series of events/states is sufficiently similar to the captured series of events/states that corresponds to a known data loss or other malicious event, then remediation can be considered.

In the embodiments discussed in detail hereunder, the information taken from observations of events a specific user's progression through a series of events/states can be captured in any time epoch and/or can be captured during any processing regime. Moreover, the information taken from and/or calculated from observations of events a specific user's progression through a series of events/states can be information that is only known or calculated based on some combination of information from (1) the electronic signature system and (2) the content management system. More particularly, when using an information combination that derives from (1) at least a portion of information from the electronic signature system and (2) at least a portion of information from the content management system, the foregoing predictive model is greatly improved in terms of precision and recall. As such, remediation activities can be invoked aggressively and with high confidence that aggressive invocation of remediation activities are not unfounded (i.e., are quantitatively supported by the data of the predictive model).

The predictive model is configured such that a quantitative risk assessment is output based on a vector of inputs (e.g., comprising combinations of information from the electronic signature system as well as the content management system). Moreover, the quantitative risk assessment includes consideration of the sensitivity of whatever content objects are made accessible during the e-signing process. Such sensitivity, and more particularly quantitative sensitivity levels, can be drawn from metadata pertaining to the amalgamation of whatever content objects are made accessible during the e-signing process. In some cases, quantitative sensitivity levels can be drawn from event histories and/or event metadata pertaining to the overall e-signing process.

In situations where the risk assessment breaches a threshold, one or more remediation actions can be invoked. Moreover, particular remediation actions can be prescribed based on the quantitative value of the assessed risk as compared to the threshold. For example, when the assessed risk is close to, but lower than the threshold, then the system might merely log (e.g., in a collaborator event dataset) the event occurrence and risk assessment as a suspected precursor event to a potential malicious event. Or, when the assessed risk slightly breaches the threshold, then the system might initiate a CMS workflow that implements ongoing forensic monitoring of system interactions by a suspected malaprop. Or, in a more extreme case where when the assessed risk significantly breaches the threshold, the system might initiate a CMS workflow that brings forth the identity of a suspected malaprop to the enterprise's legal representatives.

The techniques disclosed herein include improved approaches involving capture techniques, as well as improved techniques including, but not limited to (1) processing of changes that affect security classifications on a CMS document, (2) processing of changes made to security classifications of a user device (e.g., the device being used by a signatory), (3) processing of changes made to security classifications of a network link user device (e.g., the device being used by a signatory), (4) consideration of a legal hold being placed on a subject document, and (5) ongoing processing of CMS workflows that are invoked based on the timing and nature of activities observed during the course of securing electronic signatures.

In some embodiments, the disclosed system undertakes remediation processing so as to reduce the likelihood value that any actual or potential security vulnerabilities can be exploited. That is, during the course of carrying out one or more protocols to secure e-signatures, the system might determine that there is suspicious activity over the envelope or its constituent components. In this case, the system might associate security-related metadata with the e-sign envelope and/or its constituent components. For example, the system might associate a security flag with a particular e-sign envelope. Creation of such a security flag might raise a corresponding event, and/or might be displayed in an associated GUI screen device, and/or there might be some other sort of indication that there is at least a suspicion that a malaprop might be attempting to perpetrate unauthorized activities.

As is known in the art, a predictor pertaining to early warning of predictably soon-to-be perpetrated or suspected actual perpetration of malfeasant user behaviors can be implemented using machine learning. Specifically, real-time malfeasance prediction can be implemented using a predictive model where a set of input signals are applied to the predictive model in a manner that results in output of a malfeasance prediction from the model. A prediction of such malfeasance might result in one or more model outputs that provide a calculated risk score, and/or that cause downstream processing to raise an alert, and/or that cause downstream processing to initiate remediation actions. Possible embodiments of systems that implement any/all of the foregoing functions are shown and described in the appended figures.

### Definitions and Use of Figures

Some of the terms used in this description are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

As used herein, a “collaboration system” is a collection of executable code that facilitates sharing shared content objects and establishing a set of users who can access the shared content objects concurrently. In some embodiments as contemplated herein, a “c collaboration system” is implemented as a set of computer-implemented modules that interoperate to capture, store, and provision access to electronically-stored data (e.g., a historical record of collaborator activities) that is associated with a history of access/sharing events taken over shared content objects by two or more collaborators. Access by users to individual ones of the content objects of a content management system is controlled by collaboration group settings. A series of collaboration events for a particular collaborator is sometimes called time-wise tracking of collaboration events and is sometimes called a “user journey”.

As used herein, a collaboration group refers to any set of identifiers pertaining to users of a content management system. Such identifiers may include usernames, email aliases, user device identification information, etc. A collaboration group can be associated with any number of attributes and attribute values, and such attributes and attribute values can be inherited by the members of a particular collaboration group. The constituency of a collaboration group serves to aid in cooperative activities over collaboration system documents and metadata.

As used herein, a “content object” is any computer-readable, electronically-stored data that is made accessible to a plurality of users of a collaboration system. Different collaboration system users may each have respective permissions to access the electronically-stored data. The electronically-stored data may be structured as a file, or as a folder/directory, or as metadata, or as a combination of the foregoing. The electronically-stored data might be or might not be human intelligible. Moreover it can happen that some parts of a content object are human intelligible, while other parts of the same content object are not human intelligible. This can happen, for example, when a content object is composed of a mixture of Unicode character data as well as binary data.

As used herein, “content object deep inspection” refers to analysis of human-readable intelligence by considering the meaning of human-readable words within a collaboration object.

As used herein, the term “collaboration activities” refers to actions that involve two or more users who access the same content object of a collaboration system in the same time period. Strictly as examples, term “collaboration activities” refers to any one or more of (1) participating in a web conference, (2) participating in a multi-user real-time document editing session, etc.

An aspect or an advantage described in conjunction with a particular embodiment is not necessarily limited to that embodiment and can be practiced in any other embodiment even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

Nearly every day we see breaking news that there has been some sort of a data breach, releasing private, personal information, passwords, profiles, etc. taken from computing systems (e.g., after ‘break-in’), and then sold or otherwise released into the wild. What should be observed from this wild world is that is that the thwarting of malfeasance such as would be happening in a data breach must be triggered and carried out much earlier—long before a threat reaches the moment of actual damage. What is needed are prediction models that give proprietors of computer systems a far earlier warning that some malfeasance is likely to occur. To do so, multiple technologies need to be considered so as to populate prediction models with the information that is, whether taken singly or taken in combination, at least thought to be indicative of impending malfeasance. One area of particular concern relates to e-signature systems. It is axiomatic that malfeasance in and around the activity of signing a document is a rich source of information that is at least thought to be indicative of impending malfeasance. However, that does not go far enough.

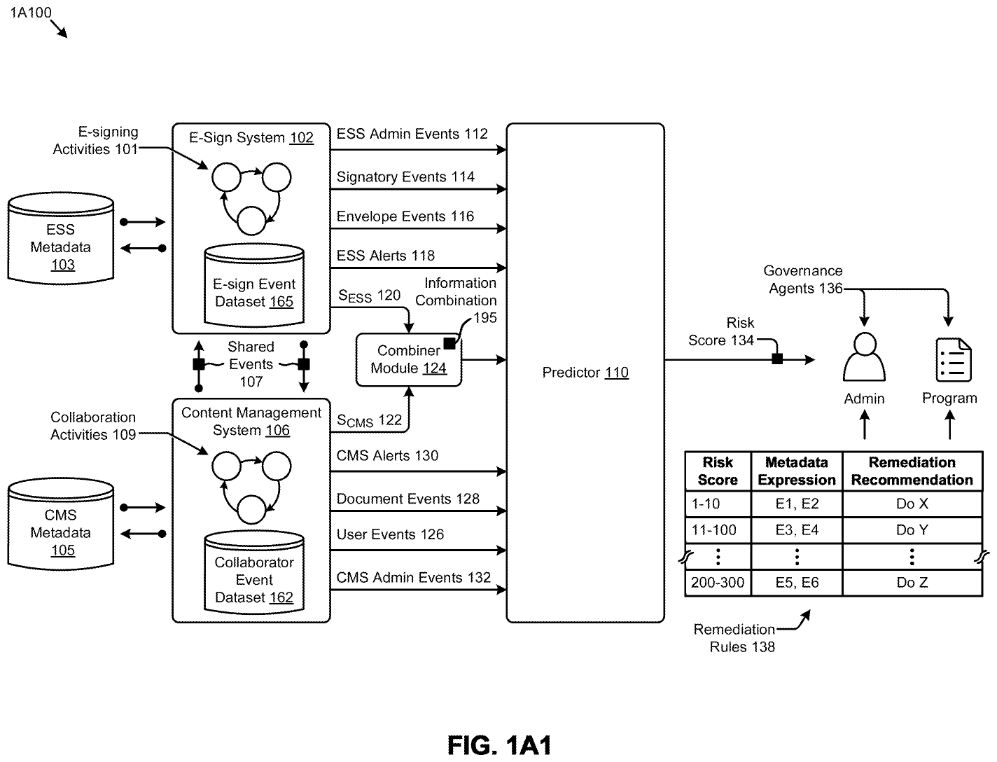

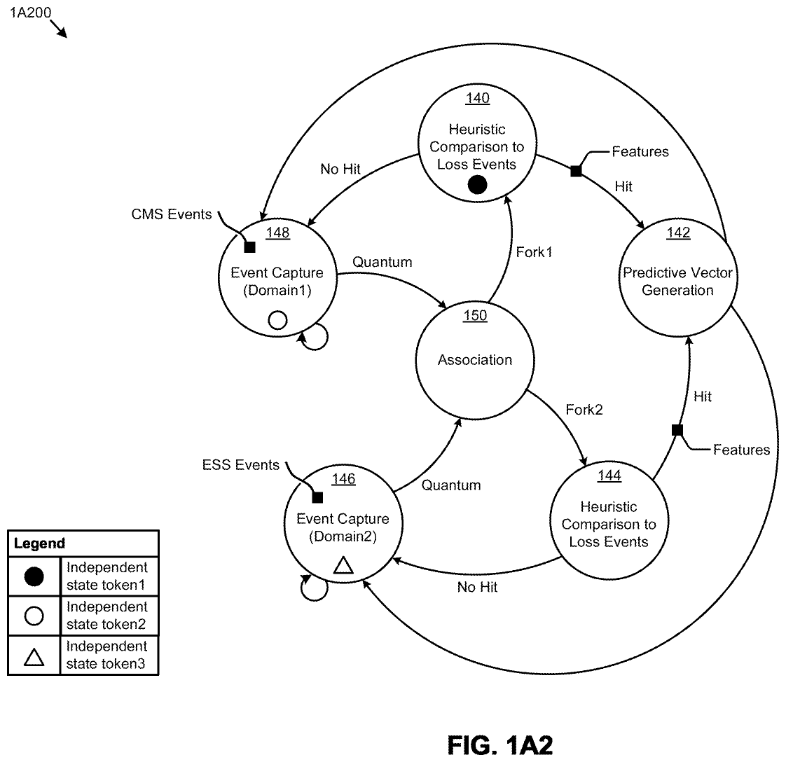

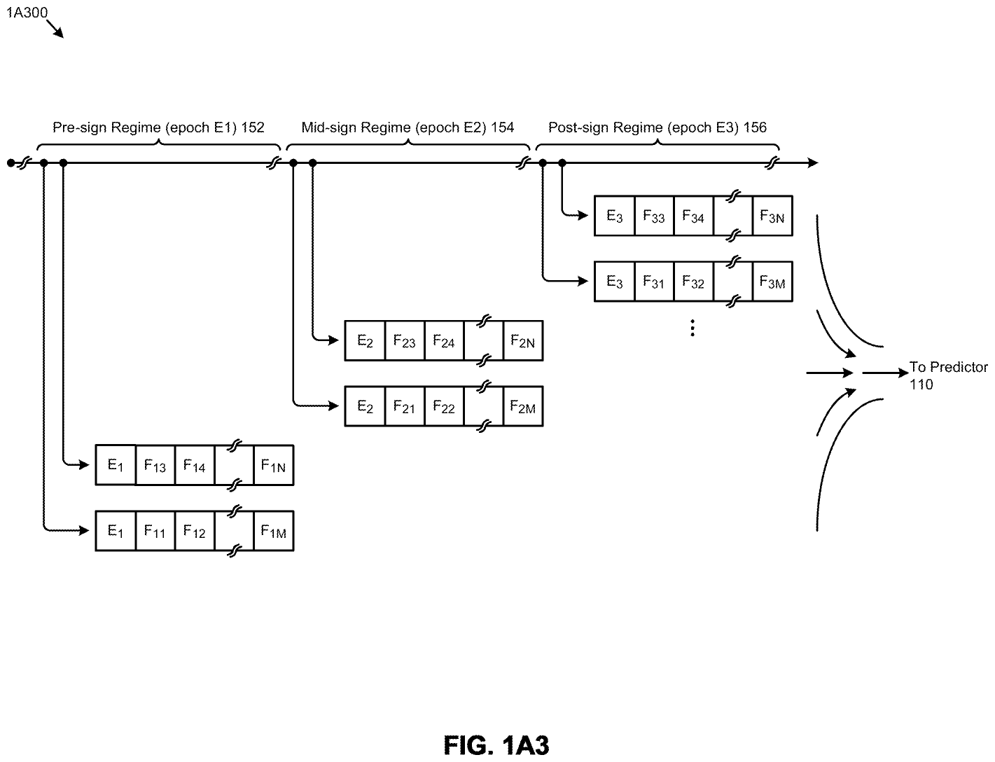

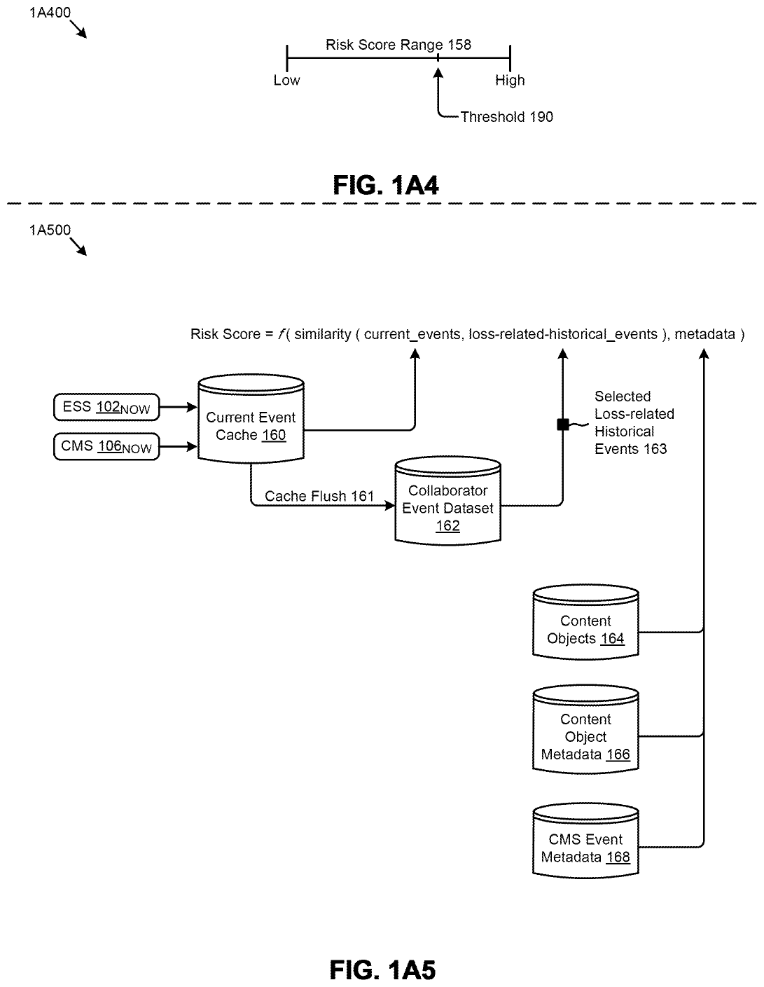

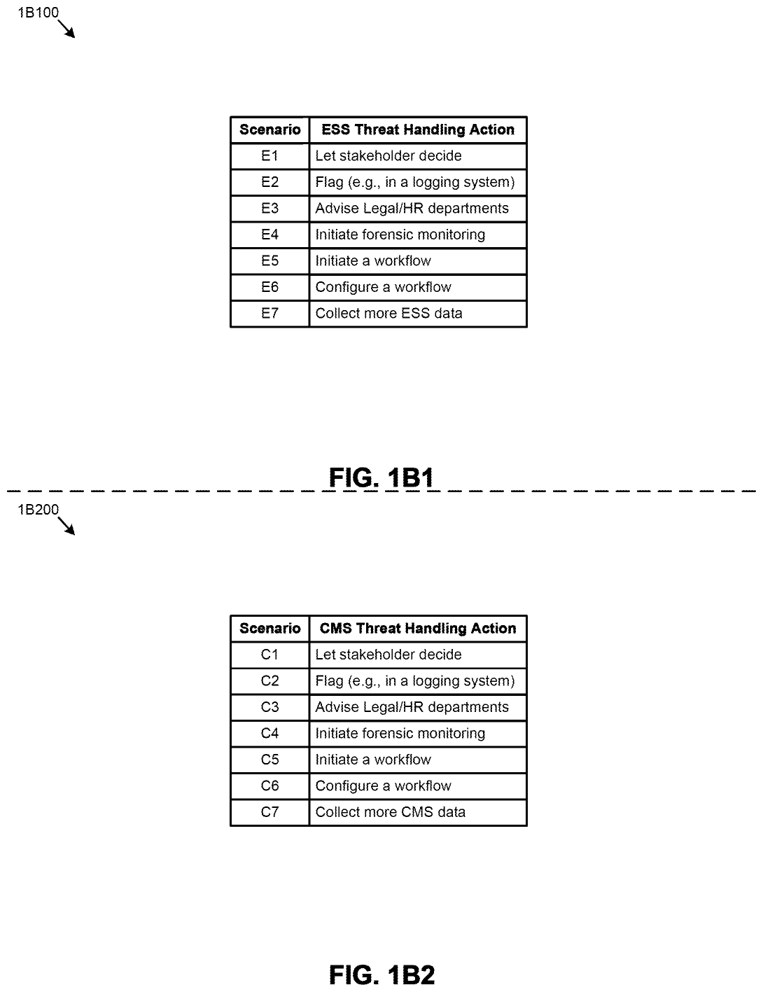

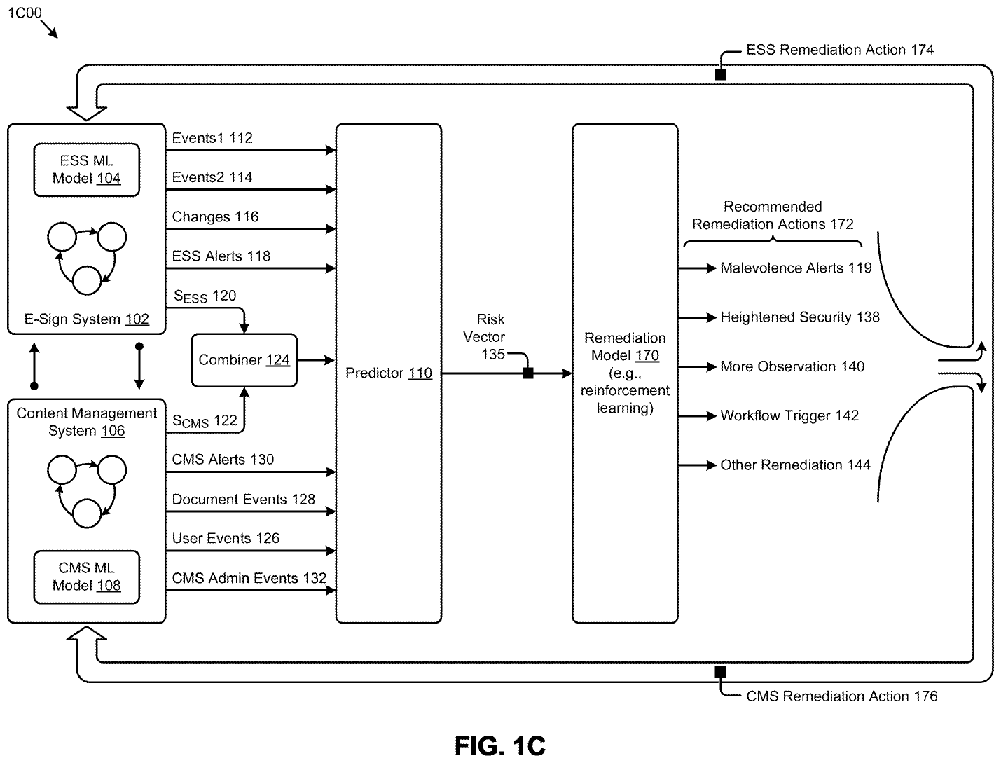

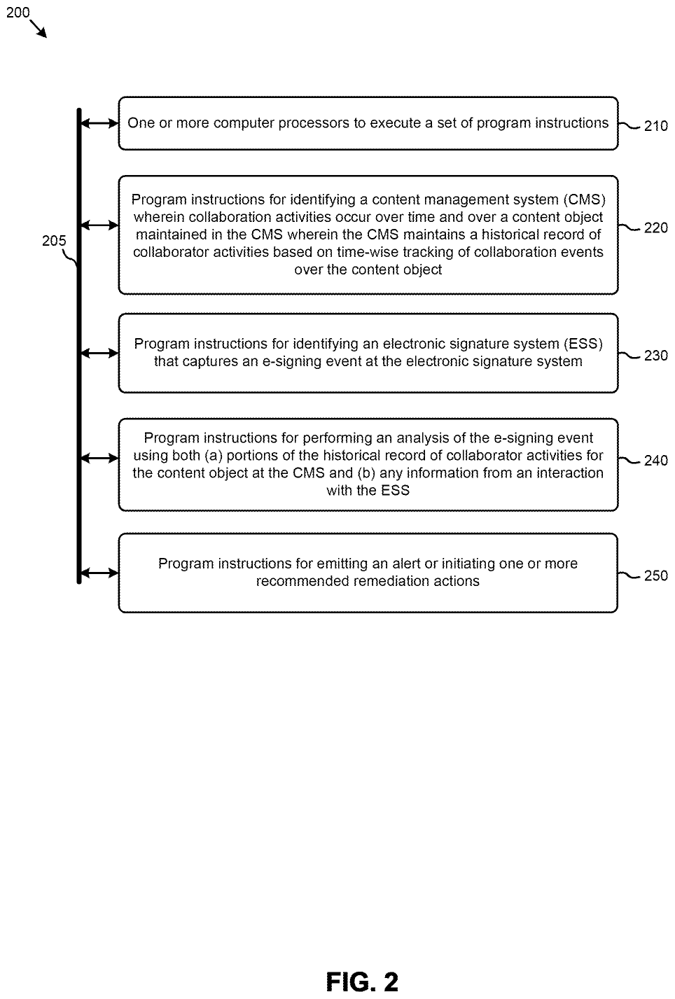

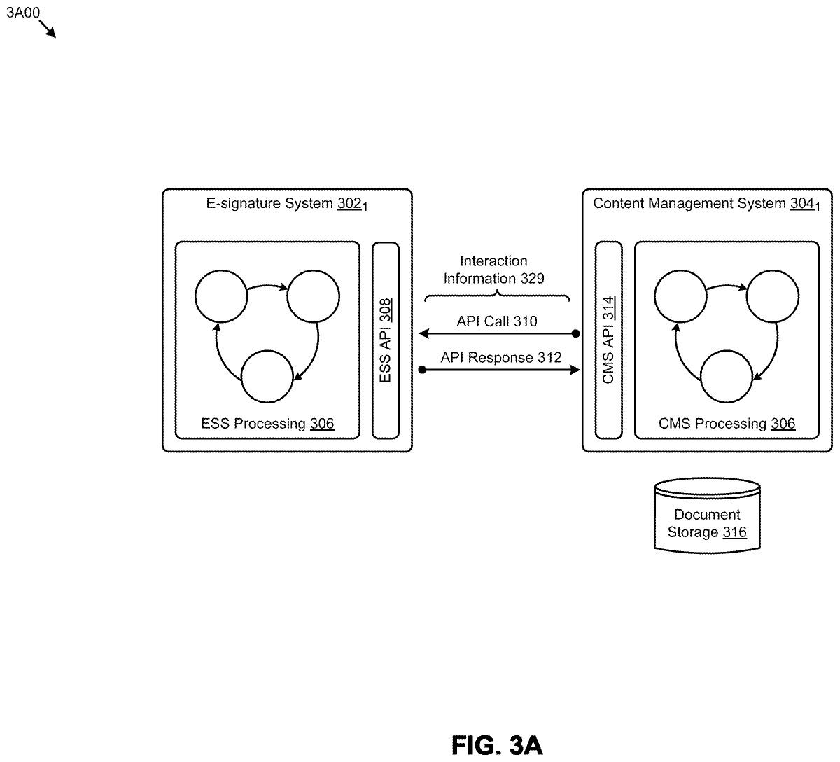

What is needed, and what is described herein, are ways to combine information from an e-signature system with information from a content management system in a manner that facilitates early prediction of impending malfeasance. One possible system for combining information from a content management system with information from an e-signature system in order to identify at least potentially suspicious activities is shown and discussed as pertains to FIG. 1A1.

More particularly, FIG. 1A1 exemplifies a threat prediction system that is configured for real-time identification of suspicious activities during e-sign processing. As an option, one or more variations of threat prediction system 1A100 or any aspect thereof may be implemented in the context of the architecture and functionality of the embodiments described herein and/or in any environment.

The figure is being presented to illustrate one embodiment of a threat prediction system that relies on predictor 110. In this particular embodiment, the model outputs a risk score 134 that can in turn be used to invoke some particular defense or remediation. In some cases, particular defense or remediation actions are undertaken by governance agents 136 (e.g., a human administrator or an executable program).

The risk score ranges shown in the example remediation rules 138 are merely for illustration and many other risk score ranges and/or risk metadata expressions, and/or many other types of events can be used when making a remediation action recommendations.

To explain, events of the ESS (e.g., e-signing activities 101) and/or events of the CMS (e.g., collaboration activities 109) may arise from changes in the states of the respective system and/or from changes in the environment (e.g., changes in the network, changes in user devices, etc.). Moreover, and as shown, events of the CMS (e.g., collaboration activities 109) can be stored in a collaborator event dataset 162 so as to be available for later reference (e.g., by querying the collaborator event dataset for specific events or relationships). Similarly, and as shown, events of the ESS (e.g., e-signing activities 101) can be stored as an e-signing event (e.g., as an entry in an e-sign event dataset 165) so as to be available for later reference. In some embodiments, the collaborator event dataset is organized as or includes a graph representation. For example, the collaborator event dataset might be organized as or includes a collaboration network graph.

Further details regarding techniques for making and using a collaboration network graph can be found in U.S. patent application Ser. No. 16/154,679 titled “ON-DEMAND COLLABORATION USER INTERFACES” filed on Oct. 8, 2018, which is hereby incorporated by reference in its entirety.

Particular ones of these events (e.g., ESS admin events 112, signatory events 114, envelope events 116, ESS alerts 118, CMS alerts 130, document events 128, user events 126, CMS admin events 132), in particular events taken from a collaboration network graph and/or from a collaborator event dataset as well as any corresponding information combination 195 drawn from any two or more sources (e.g., signals S_{ESS} 120 and signals S_{CMS} 122) are selected and analyzed so as to be used in training a predictive model. In the latter case of information combinations from signals, such signals arising from the electronic signature system 102 and content management system 106 can be associated in combiner module 124 prior to being used in the predictive model. In some embodiments the analysis of the combiner module can be performed within the combiner module, whereas in other embodiments, the analysis of the combiner module can be performed outside of the boundary of the combiner module. For example, any one or more variations or permutations of any information combination 195 drawn from the CMS and/or from the ESS can result from the foregoing analysis, wherever such analysis might be performed, even if such analysis is split across two or more execution unit boundaries. The results of the foregoing analysis may be provided, in whole or in part, as an input or as multiple inputs to a machine learning predictive model (e.g., the shown predictor 110).

Generally, the more information-laden signals that are provided to a machine learning predictive model, the greater chance that the model will exhibit desired precision and recall. Accordingly, many environmental variables are provided to the machine learning model, whether such environmental variables arise from the electronic signature system, or whether they arise from the content management system, or whether they arise from any other operational element in the environment.

In some situations, changes in the environment cause changes to system parameters (e.g., ESS metadata 103 and/or CMS metadata 105). Moreover, it can happen that events and/or metadata corresponding to events that occur in the electronic signature system can be shared advantageously with the content management system. Similarly, it can happen that events and or metadata corresponding to events that occur in this content management system can be shared advantageously with the electronic signature system. Accordingly, the embodiment of FIG. 1A1 includes a mechanism to exchange shared events 107.

Strictly as one example, a change in the CMS environment (e.g., occurrence of a network hop to a suspicious IP address) could in turn cause sharing of such an event with the ESS, which in turn would cause the ESS to modify its security parameters. As such, it can happen that during the course of collecting e-signatures over a CMS object, a change in the network environment can be determined to relate to a fraudulent or other malevolent activity. Moreover, such a determination that there is risk of fraudulent or other malevolent activity can be raised before a fraudulent signature is placed. In some cases, such fraudulent or other malevolent activity can be classified in a manner that automatically reroutes traffic or otherwise ameliorates the threat. In some cases, mere identification of such fraudulent activity can cause a real-time remediation recommendation to be raised.

A threat prediction system 1A100 such as shown in FIG. 1A1 is configured or configurable to implement a series of interrelated observation, tracking and remediation operations. For example, the shown content management system 106 is able to observe specific collaboration activities that occur over time over a content object maintained in the CMS. Moreover, the CMS is configured to maintain a first set of observations of events as entries in a collaborator event dataset that tracks the collaboration activities over the content object. Analysis of a series of two or more of such entries may reveal specific collaboration activities with respect to a specific collaborator. Similarly, the e-sign system is configured to capture a second set of observations of events at the electronic signature system. The system, in particular the ESS, has sufficient user interface capabilities such that an ESS user can initiate an e-signing event at the ESS. Furthermore, and as discussed herein, it can happen that an e-signing event operates on a content object that is maintained in the CMS.

When such analysis (e.g., as may be implemented in the combiner module 124), deems that the first observations of events are related (e.g., based on a common collaboration object) or in some way otherwise correspond to the second observations of events, aspects of the two sets of observations can be passed into predictor 110, which in turn is able to assess a risk and emit a risk score pertaining to the potential fraudulence or suspicion of the e-signing event. When this happens (e.g., when a risk score pertaining to the potential fraudulence or suspicion of the e-signing event breaches a threshold), then the system will raise an alert and/or initiate application of remediation rules 138 that cause emission of advice or initiation of one or more recommended remediation actions.

As mentioned above a predictor, or more particularly, a predictive model can be trained using information that arises from either or both of the aforementioned systems. Any known method for pre-processing event data or metadata can be used. In the environment such as exemplified in FIG. 1A1, running systems themselves can be a source of such information.

What is needed however is some technique for being able to capture events and corresponding metadata, where such events do indeed have some predictive value. One technique for gathering events and corresponding metadata involves the use of a state machine. More particularly, a multi-token state machine can be used for gathering events and corresponding metadata where there are two systems running concurrently (e.g., an ESS and a CMS) and where each of the two systems has its own set of states. Such a multi-token state machine is shown and described as pertains to FIG. 1A2.

FIG. 1A2 shows a multi-token state machine that is configured for use in systems that provide real-time identification of suspicious activities during e-sign processing. As an option, one or more variations of multi-token state machine 1A200 or any aspect thereof may be implemented in the context of the architecture and functionality of the embodiments described herein and/or in any environment.

The foregoing discussion of FIG. 1A1 pertains to merely some possible embodiments and/or ways to implement a threat prediction system. Many variations are possible; for example, the threat prediction system as comprehended in the foregoing can be implemented in an environment that includes one or more state machines (e.g., multi-token state machine 1A200) that serves to gather input events (e.g., predictive model inputs) and corresponding results (e.g., predictive model outputs) that are in turn used to populate a predictive model.

Use of a multi-token state machine is particularly convenient when data from two concurrently running systems (e.g., an ESS and a CMS) are being combined to form features that are used when formulating predictive vectors. At least inasmuch as there are many events within an ESS and similarly many events in a CMS, there is a need for identifying events and and/or their corresponding metadata in a manner that facilitates tagging of certain of those identified events as corresponding or correlating in some way to a “hit” such as an IP address anomaly indication, an access pattern anomaly indication, or a timing pattern anomaly indication. Any of the foregoing indications can be determined upon performing a statistical anomaly analysis over a user's historical activity. In some cases, a given anomalous indication from one system is compared with activities in another system so as to increase confidence that the apparent anomaly is indeed worthy of consideration in a risk model and/or is indeed worthy of consideration for remediation.

Strictly as one example, consider the situation where a user/signatory of an e-sign document is the same user/collaborator who is known to have initiated and anomalous download from the CMS. The mere occurrence of the event of an anomalous download from the CMS might not by itself trigger any remediation activities, however when the occurrence of the event of such an anomalous download is combined with additional state or event or user journey information from the CMS, it can happen that an information combination (e.g., event data from the CMS and information from the ESS) increases the likelihood value that remedial action needs to be taken. As such, collection of data from the two concurrently running systems undergoes processing to form associations between the collected data from the aforementioned two concurrently running systems.

To explain, and referring to the graphic of FIG. 1A2, assume that a state for domain1 event capture 148 can exist concurrently with a state for domain2 event capture 146. That is, event capturing in domain1 can occur simultaneously or concurrently with event capturing in domain2. As such, from time to time a quantum of events that have been captured either at state 148 or at state 146 can be provided to processing within state 150. The processing within state 150 makes associations between events that were captured in domain1 and events that were captured in domain2.

There can be many rules for making such associations, and in the situation where there is a rule to combine events from domain1 together with events from domain2, the association activities of state 150 can cause two or more different types of heuristics to be applied to one or more particular associations. This is shown by state 140 where a first type of heuristic comparison to loss events is performed with respect to all information available within domain1, and concurrently a second type of heuristics comparing to loss events can be performed with respect to all information available within domain 2. When there is a hit, that is when there is an indication emitted by either state 140 or state 144 that the events of the quantum and/or associations between events are correlated to previously known loss events, then aspects of those events and or associations between events can be provided as features which, in turn, can be used in predictive vector generation. For example, if a particular series of events (e.g., “preview”, download”, “modify”, “upload”) were known to have occurred just prior to a known loss event (e.g., misappropriation of proprietary data), then aspects of those events and or associations between events can be provided as model input features which are in turn associated with the known loss event as an output of a predictive model.

The shown state 142 performs predictive vector generation using any known technique. Such vectors can be used in training a predictive machine learning model.

As mentioned above, there may be many types of heuristics that are to be applied to one or more particular associations so as to assess if there is a hit (e.g., a prediction or presumption that there is a potentially impending loss event (or precursor to a loss event). Strictly as examples, Table 1 shows sample heuristics.

TABLE 1
Example heuristics

| Index | Meaning Tied to Usage of Events and Metadata |
|---|---|
| 1 | IP address or user agent is the same for an external user (e.g., a customer) as for an internal user |
| | (e.g., an envelope administrator). Risk can be quantified as higher (e.g., if the document to be |
| | signed is labeled as contract) as compared to a lower risk (e.g., if for example the document to be |
| | signed is a birthday card). This can be implemented by storing IP address for all users and user |
| | agents (e.g., for all sender/receiver devices), and then checking if the external user's IP address |
| | and the internal user's IP address are the same. |
| 2 | Check if the digital signature (e.g., tamper seal) has been invalidated. This might indicate that |
| | someone has attempted to change the details of an agreement using PDF editing software. |
| 3 | Check if the sender mostly sends to corporate email IDs but is now sending to a public or loosely |
| | verified email alias (e.g., to a gmail or yahoo account). |
| 4 | Check if the geolocation of signer is different from address stated in signature field. |

Events and their corresponding metadata can be gathered over an arbitrarily long period of time. More specifically, events and their corresponding metadata can occur at any moment during the carrying out of either e-signing activities or the carrying out of collaboration activities. In fact, though strictly as an example, an arbitrarily long duration of time can be divided into multiple epochs, and furthermore, each different epoch may perform some particular observation and capture of events that pertain to the happenings of that particular epoch. One way to gather epoch-specific feature vectors that are in turn used in a predictive model is shown and described as pertains to FIG. 1A3.

FIG. 1A3 depicts a multi-epoch feature vector gathering technique that is configured for use in systems that provide real-time identification of suspicious activities during e-sign processing. As an option, one or more variations of multi-epoch feature vector gathering technique 1A300 or any aspect thereof may be implemented in the context of the architecture and functionality of the embodiments described herein and/or in any environment.

In this particular example the e-sign processing is divided into three epochs: epoch E1, epoch E2, and epoch E3. This is shown by the designation of a pre-sign regime 152, a mid-sign regime 154, and a post-sign regime 156. As can be seen by inspection of the graphic of FIG. 1A3, during the pre-sign regime, the captured features (e.g., feature F13, feature F14, . . . , feature FIN) are tagged with an epoch identifier “E1” that covers the entire feature vector). Similarly, features that are captured in the mid-sign regime 154 are tagged with epoch identifier “E2”, and features that are captured in the post-sign regime 156 are identified are tagged with the identifier “E3”. In this manner, features that are specific to particular regimes can be biased so as to comport greater weight or importance or a predictive value to features that were gathered during, for example, earlier epochs. At least inasmuch as it is an objective to train a predictor 110 to emit early warnings or suspicions of malfeasance, it then follows that events that occur in earlier time frames may be more valuable for making early warning predictions.

The foregoing discussion of FIG. 1A3 pertains to merely some possible embodiments and/or ways to implement a multi-epoch feature vector gathering technique. Many variations are possible; for example, the multi-epoch feature vector gathering technique as comprehended in the foregoing can be implemented in any environment. As earlier indicated, a predictor may output a risk score, and that risk score may in turn be used to inform methods for remediation. Accordingly, there needs to be some mechanism for the computer modules to perform their respective functions on the basis of a common semantic for risk score. In one embodiment, a risk score is merely a numeric value that ranges from some low value to some high value.

FIG. 1A4 depicts a risk score representation that is configured for use in systems that provide real-time identification of suspicious activities during e-sign processing. As an option, one or more variations of risk scoring technique 1A400 or any aspect thereof may be implemented in the context of the architecture and functionality of the embodiments described herein and/or in any environment.

As shown, a risk score has a risk score range 158 that goes from a low value to a high value. Further the figure shows threshold 190 situated in the range from low to high. Any risk score representation can be used. For example, a risk score might take on a value between zero and one. The granularity of that value can be any number of bits, for example 16 bits, 32 bits, 64 bits, etc. As another example, a risk score might be represented by an integer, where a low risk score corresponds to a low integer value and a high risk score corresponds to a high integer value. A risk score, however represented, can be calculated using computerized numeric methods. One example of how to use computerized numeric methods to calculate a risk score from information available at the operational systems (e.g., an ESS system and a CMS system) is shown and described as pertains to FIG. 1A5.

FIG. 1A5 depicts an event-aware risk scoring function that combines parameters drawn from both an electronic signature system and a content management system. As an option, one or more variations of event-aware risk scoring function 1A500 or any aspect thereof may be implemented in the context of the architecture and functionality of the embodiments described herein and/or in any environment.

The figure is being presented to illustrate how and why an event-aware risk scoring function” might be configured to operate in an environment that combines parameters drawn from both an electronic signature system and a content management system. Moreover, the figure is being presented to illustrate how a set of cached events deriving from concurrently running systems can be periodically added to a collaborator event dataset such that any set of current events can be compared to historical events that have occurred in the past (e.g., back in time to an arbitrarily earlier time epoch).

Referring to the risk score function ƒ as shown in FIG. 1A5, it can be seen that the risk score value depends in part on some similarity between a set of current events and a set of historical events. More particularly it can be seen that the risk score value depends in part on the similarity between a current set of events and a set of historical events that are known to be related to loss situations. In this scenario, loss situations may refer to an actual loss event, such as when data had been leaked; or loss situations may refer to a close call to a loss event, such as when an actual loss event was thwarted. Furthermore in this scenario loss situations may refer to events that are merely correlated to predictions that there is a likelihood that a loss event is soon to occur. Strictly as one example, there might be many situations where a user/signatory of the ESS system is known to be the same user of a corresponding CMS system where the user has been terminated as an employee. Without making any particular accusation, it can be known that terminated employees are notorious for their rogue behaviors. As such, a risk score that involves interpretation of CMS events (e.g., a termination event) can be very useful as a predictor.

Now, turning our attention to the particular embodiment of FIG. 1A5, the terms that are involved in the risk score function are terms that derive from two different concurrently running systems. That is, it can happen that during the time that an ESS process is proceeding over a document to be signed, there are corresponding events happening at the CMS, possibly over the exact same document that is to be signed. During this time, electronic signature system 102_{NOW} and content management system 106_{NOW} are emitting events that are stored into a current event cache 160. Event data drawn from this current event cache can be used directly as a term in the risk score function. Periodically the current event cache 160 is flushed (e.g., via cache flush 161) into a collaborator event dataset 162. Selected loss-related historical events 163 can be drawn from the collaborator event dataset and formatted or otherwise processed in a manner that permits a set of current events to be compared with a set of loss-related historical events. Such a comparison can use any known technique. Merely as one example, a particular set of current events can be compared to many candidate sets of loss-related historical events, and each comparison can be reduced to a number which is a representation of the distance in multidimensional space between the two sets.

The embodiment of FIG. 1A5, and more particularly the risk score function, goes still farther in that metadata from the CMS can be used during calculation of a risk score. Such metadata from the CMS might be content objects 164 or it might be content object metadata 166, which, in some cases might include portions of, or abstracts of, the information within the content object. Or, such metadata from the CMS might be any arbitrary CMS event metadata 168. Referring to the foregoing example involving the terminated employee, the fact of termination of the employee can be garnered by looking up specific events in the CMS event data. Referring again to the multi-token state machine of FIG. 1A2 it can be seen that various types of heuristics can be applied over the events that had been captured at each of the tool's independently operating domains (e.g., the domain1 event capture 148 of CMS events and the domain2 event capture 146 of ESS events as shown in FIG. 1A2.)

The foregoing discussion of FIG. 1A5 pertains to merely some possible embodiments and/or ways to implement an event-aware risk scoring function. Many variations are possible, for example, the event-aware risk scoring function as comprehended in the foregoing can be implemented in any environment. Some of such environments involve remediation when a risk score breaches a threshold.

Remediation actions can take on many forms, and moreover, specific remediation actions can be invoked based on a particular range of risk score. Many threat scenarios exist and accordingly many threat handling actions (e.g., ESS remediation actions, CMS remediation actions) might be invoked, possibly very early in perpetration of some malfeasance. There are myriad scenarios where threat handling actions are invoked very early in a suspected perpetration of malfeasance. In systems such as are disclosed herein, use predictors and risk assessments are used in downstream processes that in turn prescribe remediation. Emphatically, systems such as are disclosed herein are able to handle a wide range of threats. Moreover, systems such as are disclosed herein are able to invoke remediating actions very early in a suspected perpetration. System-specific samples of remediating actions are shown and discussed as pertains to FIG. 1B1 and FIG. 1B2.

FIG. 1B1 depicts a sampling of electronic signature system threat handling scenarios. As an option, one or more variations of electronic signature system threat handling scenarios 1B 100 or any aspect thereof may be implemented in the context of the architecture and functionality of the embodiments described herein and/or in any environment.

The table is being presented to illustrate scenarios (e.g., scenario E1, scenario E2, scenario E3, scenario E4, scenario E5, scenario E6, scenario E7) that have corresponding ESS remediation actions. The particular set of remediation actions are merely examples; other remediation action can be taken. To illustrate one scenario, consider the situation where a signatory had previously been flagged as a potential malaprop by the content management system (e.g., due to one or more occurrences of anomalous downloads). In this scenario, corresponding to scenario E2, the suspected malaprop is flagged in the e-signature system as well. In another scenario, corresponding to scenario E4, forensic monitoring is invoked. The forensic monitoring might involve monitoring of a suspected malaprop's every movement. More particularly the forensic monitoring might involve ESS-driven monitoring of the suspected malaprop's interactions with the CMS.

The foregoing scenarios and recommended remediation actions are specific to an ESS system. However, there are scenarios and recommended actions that are specific to a CMS system. CMS-specific samples of remediating actions are shown and discussed as pertains to FIG. 1B2.

FIG. 1B2 depicts a sampling of content management system threat handling scenarios. As an option, one or more variations of content management system threat handling scenarios 1B200 or any aspect thereof may be implemented in the context of the architecture and functionality of the embodiments described herein and/or in any environment.

The table is being presented to illustrate scenarios (e.g., scenario C1, scenario C2, scenario C3, scenario C4, scenario C5, scenario C6, scenario C7) that have corresponding CMS remediation actions. The particular set of remediation actions are merely examples; other remediation action can be taken.

It should be noted that a CMS is particularly rich in information that can be used to predict risk as the system observes a user's activities. Strictly as one example of deep content inspection, a rational risk model might consider the actual contents of a content object in making a risk assessment and or in making a determination to raise any remediation actions. To further explain, if the content object that is, or relates to, a document to be signed via the electronic signature system and if the content object is deemed to be a contract (e.g., due to CMS tagging), then it is reasonable that if the contract value is large (e.g., say ≥$1 M), then a risk assessment value is going to be increased, which in turn would result in an earlier or more severe remediation recommendation. On the other hand, if the signature is merely a signature on a birthday card, then the risk assessment value is going to be decreased, which in turn might turn out that there are no remediation actions to be recommended.

### Risk Representation

In some embodiments, a risk score, or a risk score proxy, might be represented as a single value. In other embodiments, a risk vector, or a risk vector proxy, is represented as series of interrelated values. In some implementations a risk vector is a collection of values that represent risk in both qualitative as well as quantitative aspects. In some implementations both qualitative as well as quantitative aspects are organized into a shape that has a perimeter formed of many vertices. In some implementations both qualitative as well as quantitative aspects are organized into a security perimeter. As used herein, a security perimeter is a collection of values that correspond to respective vulnerabilities. The bounds of a security perimeter can be defined by a shape (e.g., a convex shape) having a plurality of vertices that in turn correspond to a plurality of respective risk score values that in turn correspond to a plurality of respective risk variables.

Strictly as one example, a risk might have one or more vertices that each correspond to risk-indicative values. To explain further, and returning to the previous dichotomy drawn relative to the high risk/sensitivity value of a contract versus the low risk/sensitivity value for the birthday card, one vertex might be used to quantify the sensitivity of an underlying document. Similarly, and again returning to the previous dichotomy, a further vertex might be used to quantify the clearance level (e.g., confidential, secret, top secret, etc.) of a specific user. Any number of further vertexes can be defined. Any number of vertexes can be interconnected so as to define the perimeter of a convex shape.

Continuing, content objects themselves (e.g., in content object metadata) may include precalculated instances of security parameters. Such security parameters may in turn correspond to the nature and extent of the contents of the content objects themselves. For example, a content object that is marked as “Confidential” or that contains information that is deemed to be sensitive might be associated with a high-risk score, whereas a content object that contains non-proprietary information (e.g., a birthday card to the boss) might be associated with a low-risk score. Various deep inspection modules can be configured to be able to identify risk-informing items such as the existence of personally identifiable information (PII), and/or the existence of an embedded security legend, and/or the existence of a security watermark (e.g., “Confidential,” “Secret,” “Eyes Only,” “Export Controlled,” references to business transactions, etc.). In some cases, an outboard data processing service (e.g., a third-party service) performs the actual reading and assessment of the nature of the contents of a particular content object.

Further details regarding techniques for handling security parameters can be found in U.S. patent application Ser. No. 18/346,137 titled “DEFINING A SECURITY PERIMETER USING KNOWLEDGE OF USER BEHAVIOR WITHIN A CONTENT MANAGEMENT SYSTEM” filed on Jun. 30, 2023, which is hereby incorporated by reference in its entirety.

FIG. 1C exemplifies a threat remediation system that initiates remediation actions based on deemed suspicious activities that are identified during e-sign processing. As an option, one or more variations of threat remediation system 1C00 or any aspect thereof may be implemented in the context of the architecture and functionality of the embodiments described herein and/or in any environment.

The figure is being presented to illustrate how a threat remediation system might be configured to operate in an environment that initiates remediation actions based on a risk vector. In this particular embodiment, a remediation model 170 is driven by predictor 110. Outputs from the remediation model are recommended remediation actions 172 (e.g., malevolence alerts 119) that are in turn considered and/or carried out by either the ESS (e.g., carried out by ESS processing of an ESS remediation action 174) or by the CMS (e.g., carried out by CMS processing of a CMS remediation action 176).

As shown, the remediation model takes as inputs a risk vector and emits one or more remediation actions. In this particular embodiment, the remediation model implements reinforcement learning. Reinforcement learning (RL) is an interdisciplinary area of machine learning that is concerned with how an intelligent agent (e.g., remediation model) needs to take actions in a dynamic environment in order to maximize the cumulative reward. In some cases, a remediation model is integrated with a further model that receives sufficient inputs so as to implement one or more techniques for calculating a trend based at least in part on a time-ordered series of first observations of events and/or a time-ordered series of second observations of events. The foregoing time-ordered series of first observations of events as well as the foregoing time-ordered series of second observations of events can be drawn from content management system 106 and/or from electronic signature system 102, respectively. Such calculated trends may be provided to a reinforcement learning facility, which is hereunder briefly discussed.

As is known in the art, reinforcement learning differs from other ML learning in not needing labelled input/output pairs to be presented, and in not needing sub-optimal actions to be explicitly corrected. Instead, the focus is on finding a balance between exploration (e.g., of the effect of taking actions) and exploitation (of then-currently-known results of earlier-taken actions) with the goal of maximizing the long term reward. In some scenarios, such as discussed herein, it happens that the results of taking any particular remediation action (e.g., feedback) might not be known until some moment in the future. Moreover, in some situations observable results of taking any particular remediation action might be incomplete or still further delayed. Nevertheless, the shown remediation model is able to output (e.g., recommend) what is then-currently deemed to be the best remediation action given a particular risk vector 135.

The output remediation actions can be delivered directly to the ESS and/or delivered to the CSS (or both), and/or the output remediation actions can be wrapped in an executable agent before being delivered to the ESS and/or before being delivered to the CMS. In the former case, when delivering particular remediation actions to either the ESS and/or to the CMS, a respective machine learning model (e.g., ESS ML model 104, CMS ML model 108) can be engaged.

The foregoing discussion of FIG. 1C pertains to merely some possible embodiments and/or to some ways to implement a threat remediation system. Many variations are possible; for example, the threat remediation system as comprehended in the foregoing can be implemented in any environment, one example of which is shown and described as pertains to the following figure.

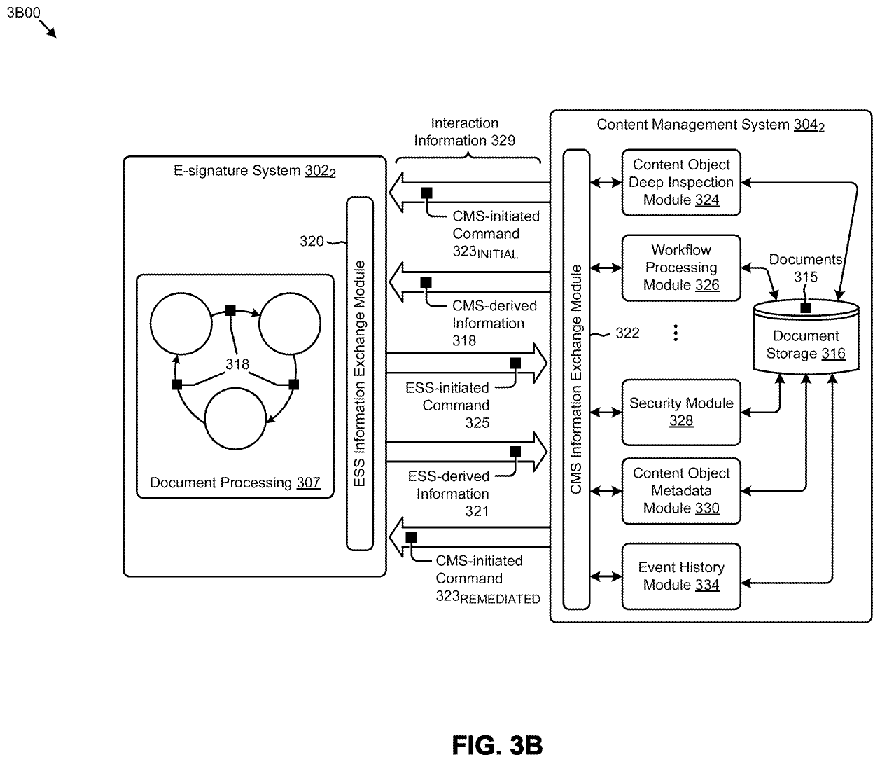

FIG. 2 presents a flowchart depicting certain operations of a suspicious activity remediation system 200. As an option, one or more variations of suspicious activity remediation system or any aspect thereof may be implemented in the context of the architecture and functionality of the embodiments described herein and/or in any environment.

As an option, system 200 may be implemented in the context of the architecture and functionality of the embodiments described herein. Of course, however, the system or any operation therein may be carried out in any desired environment. As shown, the system comprises a plurality of modules, a module comprising at least one processor and a memory, each connected to a communication link 205, and any module can communicate with other modules over communication link 205. The modules of the system can, individually or in combination, perform method steps within system 200. Any method steps performed within system 200 may be performed in any order unless as may be specified in the claims. As shown, system 200 implements a method, the system 200 comprising modules for: identifying a content management system (CMS) wherein collaboration activities occur over time and over a content object maintained in the CMS wherein the CMS maintains a historical record of collaborator activities based on time-wise tracking of collaboration events over the content object (module 210); identifying an electronic signature system (ESS) that captures an e-signing event at the electronic signature system (module 220); performing an analysis of the e-signing event using both (a) portions of the historical record of collaborator activities for the content object at the CMS and (b) any information from an interaction with the ESS (module 230); and emitting an alert or initiating one or more recommended remediation actions (module 240).

FIG. 2 depicts a block diagram of a system to perform certain functions of a computer system. As an option, system 200 may be implemented in the context of the architecture and functionality of the embodiments described herein. Of course, however, system 200 or any operation therein may be carried out in any desired environment. As shown, system 200 comprises at least one processor and at least one memory, the memory serving to store program instructions corresponding to the operations of the system. An operation can be implemented in whole or in part using program instructions accessible by a module. The modules are connected to a communication path 205, and any operation can communicate with any other operations over communication path 205. The modules of the system can, individually or in combination, perform method operations within system 200. Any operations performed within system 200 may be performed in any order unless as may be specified in the claims. The shown embodiment implements a portion of a computer system, presented as system 200, comprising one or more computer processors to execute a set of program code instructions (module 210) and modules for accessing memory to hold program code instructions to perform: identifying a content management system (CMS) wherein collaboration activities occur over time and over a content object maintained in the CMS wherein the CMS maintains a historical record of collaborator activities based on time-wise tracking of collaboration events over the content object (module 220); identifying an electronic signature system (ESS) that captures an e-signing event at the electronic signature system (module 230); performing an analysis of the e-signing event using both (a) portions of the historical record of collaborator activities for the content object at the CMS and (b) any information from an interaction with the ESS (module 240); and emitting an alert or initiating one or more recommended remediation actions (module 250).

The foregoing discussion of FIG. 2 pertains to merely some possible embodiments and/or ways to implement a suspicious activity remediation technique. Many variations are possible. For example, the suspicious activity remediation technique as comprehended in the foregoing can be implemented in any environment or even in multiple environments such as when the ESS is embodied in a different environment than the CMS. Such environments might correspond to integrations (e.g., ESS integrations with a CMS, or CMS integrations with an ESS), which integrations are operated by third parties. Examples of such integrations (e.g., loosely integrated application programming interface (API) integrations, tight bi-directional integrations, etc.) are shown and described as pertains to the following figures.

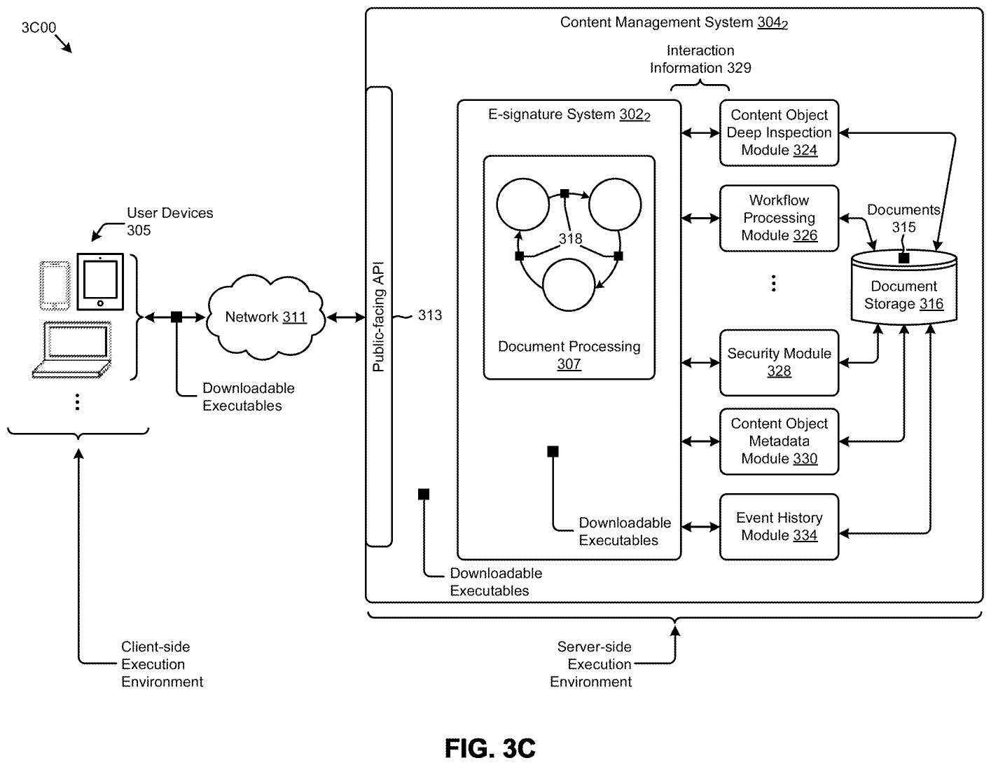

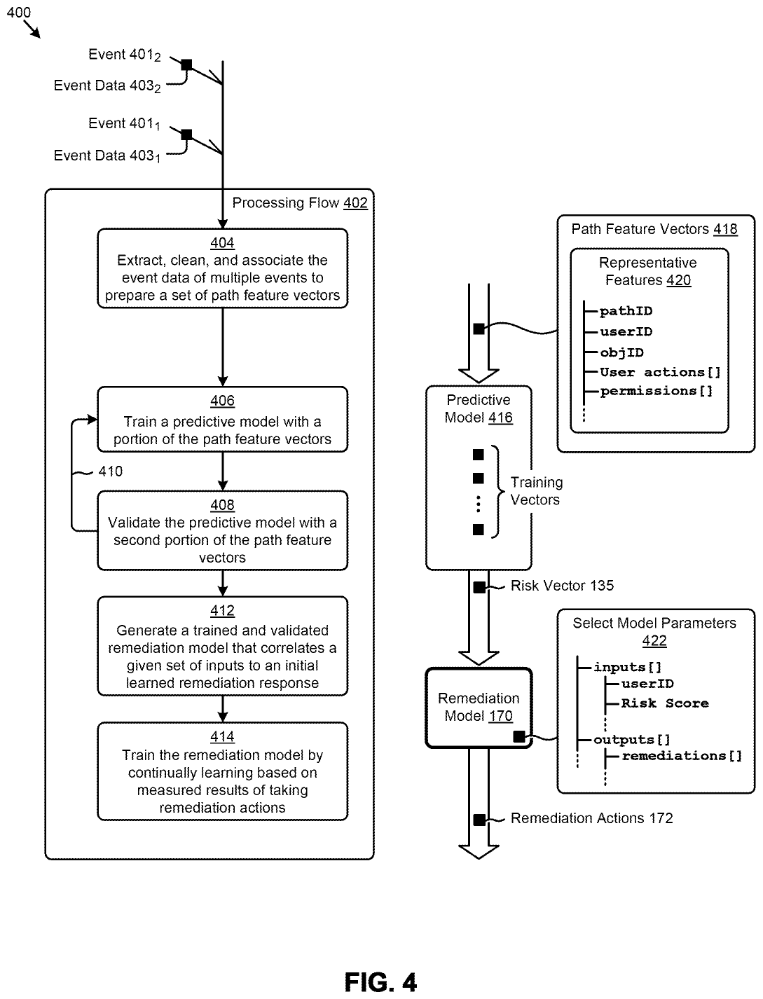

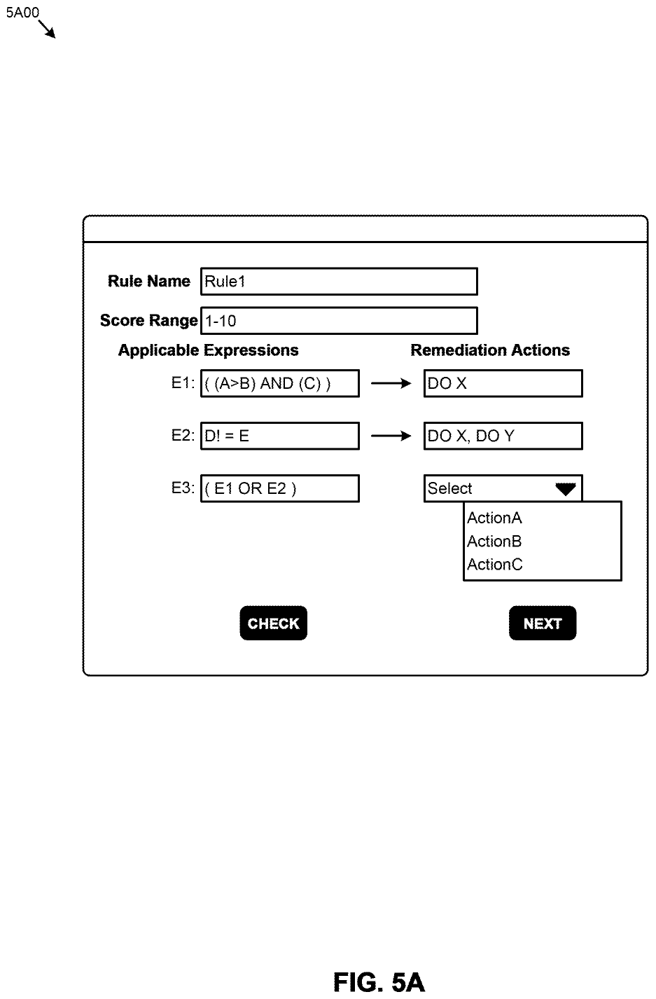

FIG. 3A exemplifies an API-based architecture 3A00. FIG. 3B and FIG. 3C exemplify variations of bidirectional data-enriching architectures. As an option, one or more variations of the architectures or any aspect thereof may be implemented in the context of the architecture and functionality of the embodiments described herein and/or in any environment.

Figures FIG. 3A, FIG. 3B, and FIG. 3C are being presented in succession to illustrate some of the differences between architectures. More particularly, figures are being presented in succession to illustrate how bidirectional data-enriching operations can be carried out in the architectures and interfacing topologies of FIG. 3B and FIG. 3C, whereas the architecture of FIG. 3A supports CMS interactions with the ESS without such bidirectional data-enriching operations. This is illustrated, for example, by comparing the inner workings of content management system 304₁ of FIG. 3A with the inner workings of content management system 304₂ of FIG. 3B. Specifically, in content management system 304₁ of FIG. 3A, documents 315 in document storage 316 are behind an API wall such as the shown CMS API wall 314, whereas the inner workings of content management system 304₂ of FIG. 3B show a fully-featured instance of CMS information exchange module 322. In any/all of the embodiments of FIG. 3A, FIG. 3B, and/or FIG. 3C, interaction information 329 is observable from any module of any system.

In an architecture such as is shown in FIG. 3A, content management system 304₁ interacts with e-signature system 302₁ by making an API call 310 to the e-signature system 302₁ and receiving an API response 312. An API call and a corresponding API response may have to go through an e-signature system API wall (e.g., the shown ESS API wall 308) before the e-signature system 302₁ can initiate ESS processing 306. As such, in this architecture, only those functions that are raised by the CMS (e.g., via an API call) can be facilitated by the ESS.

Although the architecture of FIG. 3A is deficient as heretofore discussed, an architecture that facilitates a bidirectional information exchange and/or an architecture that facilitates raising events from either the CMS or from the ESS overcomes the foregoing deficiencies. One architecture that supports both bidirectional information exchange and that supports the raising of events from either the CMS or from the ESS is shown in FIG. 3B as architecture 3B00.

Specifically, content management system 304₂ interfaces with the e-signature system 302₂ over the shown CMS information exchange module 322, which in turn interfaces with the shown ESS information exchange module 320. The implementation of such information exchange modules facilitates forms of document processing 307 that take into account a rich set of information that is available in a CMS. In the other direction, implementation of such information exchange modules facilitates forms of document processing within the CMS that would not be possible in the absence of a bidirectional information exchange between the CMS and the ESS.

Strictly as an example scenario, there may be security vulnerabilities that are discovered during the course of signing a document, which security vulnerabilities or other risks might be remediated in conjunction with the CMS by hardening the security protection around the document (e.g., increasing an encryption key bitlength or requiring multi-factor authentication) or by carrying out other remediation steps. Such remediation techniques can be carried out independent of any particular architecture or functionality, some of which are shown and discussed below as pertains to FIG. 3B and FIG. 3C.

FIG. 3B exemplifies a bidirectional data-enriching architecture. As shown, in the example architecture of FIG. 3B, a data-enriching scenario might emerge as follows: (1) The content management system 304₂ raises a request to the e-signature system 302₂ (e.g., via CMS-initiated command 323_{INITIAL}), which may be accompanied or followed by CMS-derived information 318; (2) the e-signature system 302₂ performs document processing 307 using the CMS-derived information 318 and, during the course of such document processing, the e-signature system 302₂ determines that the content management system 304₂ needs to be apprised of one or more aspects of ESS-derived information 321; (3) the e-signature system 302₂ raises an ESS-initiated command 325 to the CMS; (4) the CMS performs remediation and/or instructs the ESS to perform remediation; and (5) the content management system 304₂ raises a new request to the e-signature system 302₂ via CMS-initiated command 323_{REMEDIATED}.

In further detail, (1) the content management system 304₂ raises a command (e.g., a CMS-initiated command 323_{INITIAL}) to sign a document that has been deemed to be ready for signing; (2) the e-signature system 302₂ performs document processing 307 using CMS-derived information 318 and, during the course of such document processing, the e-signature system 302₂ determines that the network over which the document is being signed includes an IP hop that is insecure (e.g., at an Internet cafe); (3) the e-signature system 302₂ raises an ESS-initiated command 325 to the CMS to advise the CMS of the security vulnerability; (4) based on the specific vulnerability, the CMS performs remediation such as by encrypting the document and requiring a multi-factor authentication; and (5) the content management system 304₂ raises a new request to the e-signature system 302₂ via CMS-initiated command 323_{REMEDIATED} so as to cause the e-signature system 302₂ to acquire the needed signature after authentication.

Strictly as one example, an ESS-initiated command 325 might be a request for the CMS to gather some specific information and/or to allow or deny some proposed action that is a candidate-proposed action to be taken by the ESS only upon allowance provided by the CMS.

The foregoing is merely one illustrative scenario. Many other scenarios cover many other situations, including many other situations where a security vulnerability is detected and indicated by the ESS and then remediated by the CMS, as well as other situations where a security vulnerability is detected and indicated by the CMS and then remediated by the ESS.

Now, referring again to the bidirectional information exchange as exemplified by FIG. 3B, a CMS can be configured with any number of modules that can carry out specific types of processing, the results of which processing can be used to enrich the exchange of information between modules of a CMS and modules of an ESS. The specific embodiment of FIG. 3B includes content object deep inspection module 324, workflow processing module 326, security module 328, content object metadata module 330, event history module 334, as well as other modules. Any/all of the foregoing modules can store/retrieve to/from content object storage. Moreover, any of the foregoing modules of the CMS can be configured to communicate with any other module of the CMS. As one illustrative example, workflow processing module 326 might determine that a contract is ready for multi-party signing. In preparation for carrying out a next step in the workflow, the workflow module might interrogate the content object metadata module to determine if the contract is associated with any particular handling requirements. The content object metadata module might in turn interrogate the security module to determine specifics as for handling the contract within the bounds of, for example, a user-established security regime.

FIG. 3C is a flowchart depicting suspicious activity remediation technique. As an option, one or more variations of suspicious activity remediation technique 3C00 or any aspect thereof may be implemented in the context of the architecture and functionality of the embodiments described herein and/or in any environment.

As shown, FIG. 3C exemplifies a unified bidirectional data-enriching architecture. In this architecture, the e-signature system 302₂ is composed of executables that are situated within content management system 304₂. As such, e-signature system 302₂ can interface directly with any of the modules (e.g., content object deep inspection module 324, workflow processing module 326, security module 328, content object metadata module 330, event history module 334) of the content management system. In some cases, e-signature system 302₂ can have direct access to documents 315 of document storage 316.

User devices 305 interact with the e-signature system over/through network 311. In some embodiments, e-signature system 302₂ hosts downloadable executables that can be retrieved from any of a variety of user devices (e.g., smartphones, tablets, and laptops, such as are shown). The user devices execute portions of the downloadable executables so as to interact with the content management system and/or the e-signature system. In some cases, the user devices execute the downloadable executables so as to interact with the content management system and/or the e-signature system via a public-facing API 313. The public-facing API can access any module of the CMS and/or any document 315 of the CMS. Furthermore, the e-signature system and/or the content management system 304₂ can host additional executable modules that implement at least a portion of the Internet-based interface.

For example, the e-signature system and/or the content management system 304₂ can host additional executable modules that are downloadable to a user device. As such, once applicable executable modules have been downloadable to a user device, the user device can perform any functions or interactions of the ESS or CMS that are codified into the downloadable executable modules.

Any combination of interactions between the user devices and the content management system, and/or between the user devices and the e-signature system, and/or any interactions between any of the constituent modules of the CMS may be carried out in any order. Moreover, any combination of interactions between modules of the CMS and modules of the ESS may be carried out in any order. To accommodate flexible multi-module data gathering and processing by and between modules of a CMS and/or by and between a CMS and an ESS, an event-driven system may be implemented.

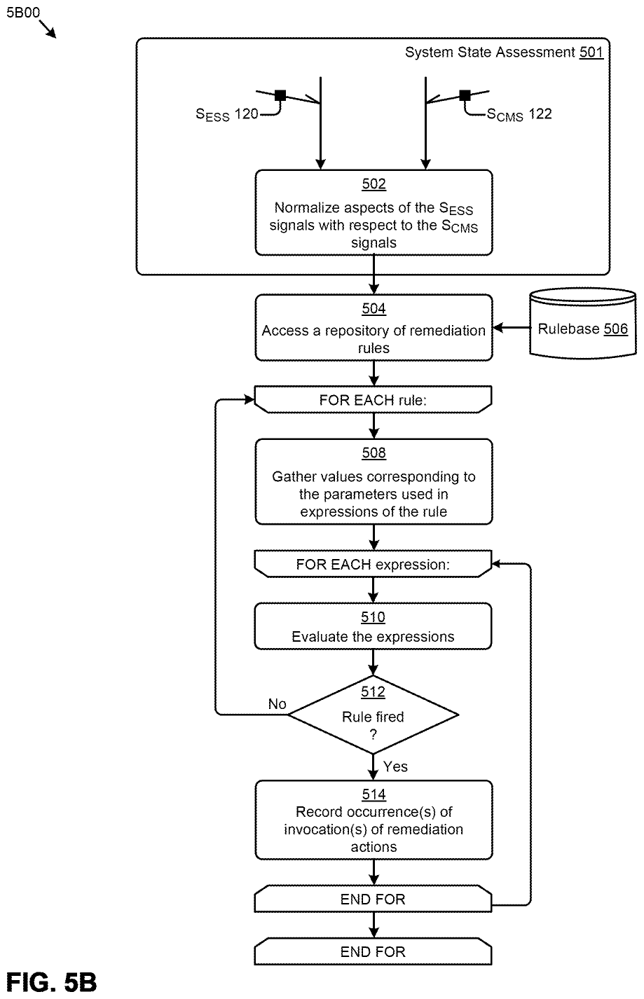

FIG. 4 is a flowchart depicting a remediation model generation system. As an option, one or more variations of remediation model generation system 400 or any aspect thereof may be implemented in the context of the architecture and functionality of the embodiments described herein and/or in any environment.

The figure is being presented to illustrate how and why a remediation model generation system might be configured. As shown, processing flow 402 is invoked upon an incoming event (e.g., event 401₁ together with its event data 403₁) Additional incoming events (e.g., event 401₂) and corresponding data (e.g., event data 403₂) might follow. For each incoming event, step 404 serves to extract, clean, and associate the event data of incoming events to prepare a set of path feature vectors. Once a set of path feature vectors have been prepared, then processing advances to step 406, at which time step 406 uses the path feature vectors 418 to train a predictive model 416 with a first portion of the path feature vectors. There may be a second portion of path feature vectors that are used to train the predictive model, however the second (or Nth) portion of path feature vectors is used when the validation processing (step 408) determines that such an additional second set of path feature vectors is needed in order to bring the predictive model to some particular desired degree of precision and recall. In the event that, indeed, an additional set of path feature vectors is needed, then loop 410 is taken and step 406 is again executed to train the predictive model with further path feature vectors. On the other hand, if step 408 or an alternative processing step deems that the quality of the then-currently trained predictive model is sufficient, then processing proceeds to step 412.

Step 412 serves to generate a trained and validated remediation model that correlates a given set of inputs to an initial learned remediation response. The foregoing given set of inputs (e.g., representative features 420) might be associated with a predetermined output (e.g., a loss event), in which case the predictive model is at first trained with inputs and corresponding predetermined response(s). Additionally, or alternatively, further sets of inputs and a learned response can be brought into the predictive model based on reinforcement learning algorithms. In this manner the predictive model can be trained (1) using some portion of training vectors that are predetermined (e.g., using one or more forms of supervised learning), and (b) using in-situ learned responses (e.g., using unsupervised learning techniques). As such, predictive model 416 can be trained such that a particular path (e.g., corresponding to the shown “pathID”) for a particular user (e.g., corresponding to the shown “userID”), and such that a user's particular actions (corresponding to the shown “user actions[ ]” array) over a particular content object (e.g., the shown “objID) are both included in the model. In some cases, path feature vectors also include a scalar or an array of permissions (e.g., the shown “permissions[ ]”).

When trained in accordance with the foregoing, or in a similar manner, the predictive model can output a risk vector 135 based on stimulating the model with a then-current set of path feature vectors. In this embodiment, the risk vector is sufficiently rich such that the risk vector can be used as input to remediation model 170 such that one or more remediation actions are emitted from the remediation model.

Strictly to illustrate by example, remediation model 170 includes select model parameters 422 that are selected specifically for their predictive value. In this example, the select model parameters includes inputs in the form of a userID and a risk score. Such a risk score can be one vector member of risk vector 135. Additionally, the select model parameters includes outputs (e.g., the shown “outputs[ ]” vector), which in turn may define various forms of recommended remediation actions (e.g., in members of the shown “remediations[ ]” vector).

As can now be understood, processing flow 402 results in (1) ongoing training and enrichment of the predictive model (step 406) based on processing of continually incoming events, as well as (2) training (step 408) and ongoing re-training (step 414) of the remediation model by continually learning improved remediation actions based on unsupervised learning from measured results of taking various previously invoked recommended remediation actions 172.

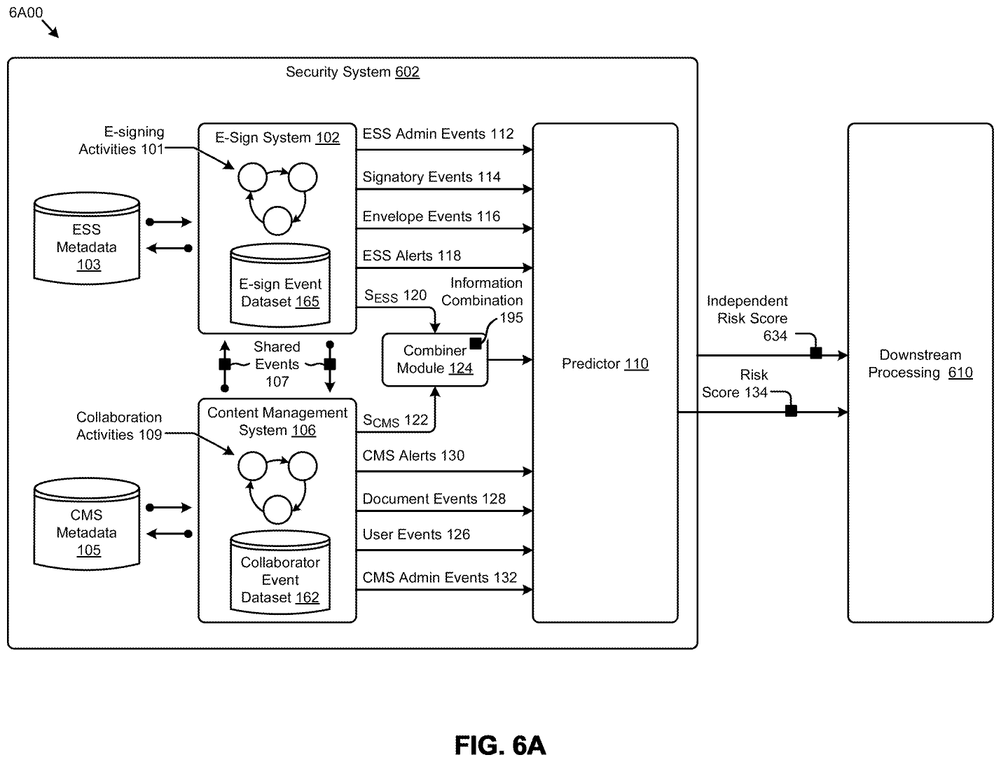

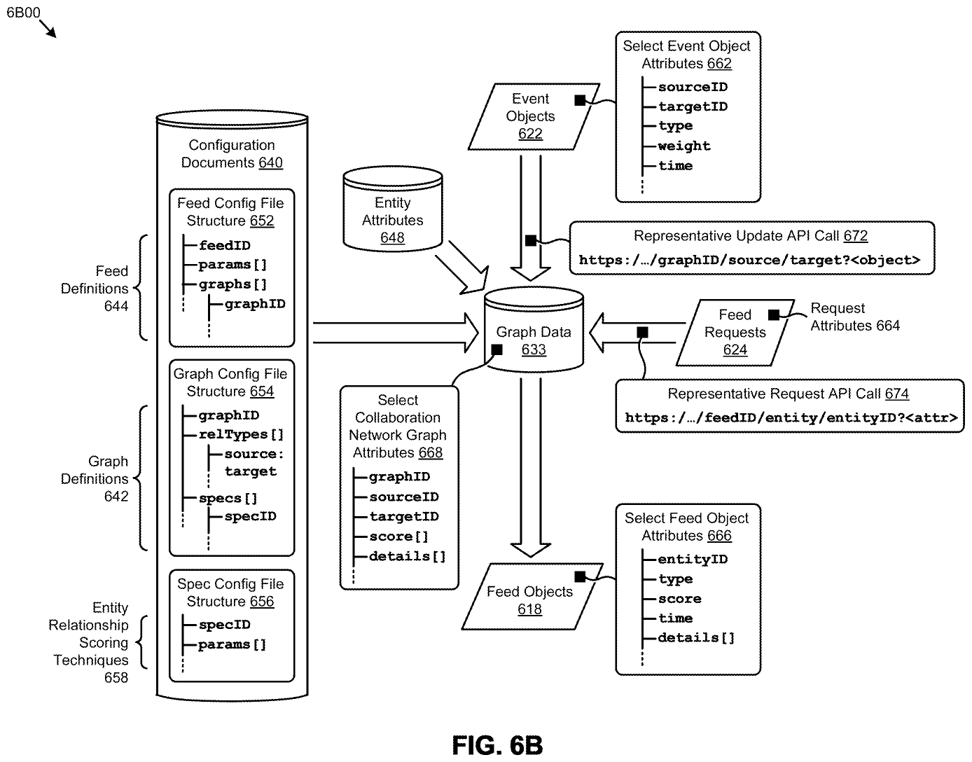

The foregoing discussion of FIG. 4 pertains to merely some possible embodiments and/or ways to implement a remediation model generation system. Many variations are possible, for example, the remediation model generation system as comprehended in the foregoing can be implemented in any environment. In fact, some initial training vectors might be generated based on a state, possibly a multi-valued state, of the overall system when a remediation rule is fired. One way to define such a remediation rule is shown and described as pertains to FIG. 5A.

FIG. 5A depicts an example user interface for defining remediation rules. As an option, one or more variations of user interface 5A00 or any aspect thereof may be implemented in the context of the architecture and functionality of the embodiments described herein and/or in any environment.

The figure is being presented to illustrate how and why a user interface might be configured to operate in an environment for defining remediation rules. As shown, a remediation rule has a name (e.g., the shown “Rule Name”), a first condition to be satisfied before firing (e.g., the shown “Score Range”), one or more second or Nth conditions to be satisfied before firing (e.g., the shown “Applicable Expressions”), and a rule result or triggers (e.g., the shown “Remediation Actions”) that are activated when the conditions are satisfied. In this illustrative example, there are three applicable expressions for this rule: (1) expression “E1”, expression “E2”, and expression “E3”. Each expression has a respective action, specifically (and as shown), “E1” has a respective action “DO X”, and “E2” has a respective action “DO X, DO Y”. Strictly for further illustration, an action for expression “E3” is not yet defined, however user interface 5A00 has a graphical user interface provision for a user to select one (or more) actions from a set of predefined actions (as shown by pulldown choices “ActionA”, “ActionB”, and “ActionC”).

As is understood by those of skill in the art, expression definitions can be chained. The chained expression shown (“E3”) uses previously defined expression “E1” and expression “E2” and a Boolean “OR” to form a chained compound expression.

The foregoing discussion of FIG. 5A pertains to merely some possible embodiments and/or ways to implement a user interface to define remediation rules. In exemplary cases, a plurality of remediation rules are gathered together into a rulebase, and such a rulebase can be accessed at any moment in time, in particular whenever there is a potential rule triggering state change (e.g., when a state variable changes value). One example of rule triggering is shown and described as pertains to the FIG. 5B.

FIG. 5B depicts an example rule triggering technique as used in systems for real-time identification of suspicious activities during e-sign processing. As an option, one or more variations of rule triggering technique 5B00 or any aspect thereof may be implemented in the context of the architecture and functionality of the embodiments described herein and/or in any environment.

The figure is being presented to illustrate how a rule triggering technique might be configured to operate in environments such as heretofore described. As per the foregoing discussion, rules can be fired (e.g., so as to invoke remediation actions) whenever there is a potential rule triggering state change (e.g., when a rule-triggering state variable changes value). Accordingly, there needs to be some mechanism to detect such a triggering state change. The facility shown as system state assessment 501 provides such a mechanism. Further, the facility shown as system state assessment 501 serves to normalize incoming signals (e.g., incoming signal S_{ESS} 120 and incoming signal S_{CMS} 122) in a manner such that certain values of the incoming signals are prepared as inputs to the remediation rules (step 502).

Step 504 accesses rulebase 506 to identify any/all candidate rules that are sensitive to the aforementioned rule-triggering state variable changes. Then, for each such rule, step 508 serves to gather any remaining state (or other) values that would be needed to evaluate expressions of a rule. Next, each expression of a candidate rule is evaluated (step 510) and decision 512 is taken based on whether or not the rule fired (e.g., the expression was deemed to evaluate to TRUE). For each rule that did fire, then the “Yes” branch of decision 512 is taken and step 514 (at least) records the occurrence(s) of invocation(s) of remediation actions. In this manner, any reinforcement learning modules can recognize the occurrence and correspondingly and autonomously instrument the system so as to observe the system response to the remediation actions. In some cases, the instrumentation demands some input from a user/administrator to assess the efficacy of the remediation. In some embodiments, the efficacy of a given remediation is based on whether or not any further anomalies or suspicious activities are detected. That is, strictly to illustrate, if a suspected malaprop sees a warning banner on his/her screen, “Your interactions are being recorded,” then that warning by itself might be sufficient to thwart further malicious activities.

### Early Warning

The notion of early warning, combined with the idea of real time detection, cannot be overstated. Whereas in legacy systems there might have been sufficient forensic information available to identify a perpetrator, a deficiency of legacy systems is that this identification is provided only after the damage has been done. As such, early identification of a perpetrator or perpetrators of suspected malicious activities is a long-felt need that the current disclosure addresses. Take for example the situation where a rogue employee, in this case, a salesperson, fraudulently signed an e-sign signature on behalf of the salesperson's customer. This results in what appears to be a legitimate purchase agreement, including actual payment, however it was in fact a fraudulent e-sign. In this particular case, the IP address of the rogue employee was the same IP address as the initiator of the e-sign envelope.

The fact that the IP address of the rogue employee was the same IP address as the initiator of the e-sign envelope—by itself—would not necessarily indicate malicious activity, however, when the fact is combined with the fact that the rogue employee had been terminated and was finishing up their last days of employment could have been used as an early warning predictor that malfeasance was about to occur. Further, consider a slightly more sophisticated malaprop who recognizes that using the same IP address of the sender as well as signatory would be incriminating, the malaprop might use a remotely located server as a repeater so as to purposely make it such that the sender's IP address and the signee's IP address were different. This situation can nevertheless be observed by machine learning that can identify this sort of spoofing. The foregoing malicious use cases illustrates the need for both early warning prediction as well as the early initiation of remedial actions.

Any of the foregoing situations can be brought to the attention of an administrator or other stakeholder who can in turn take further action. Strictly as one example, an administrator might decide to rescind the e-sign envelope or otherwise halt progression of the e-sign process until such time that the surfaced threat can be validated. That is, it is possible that the predictor outputs and/or the specific risk score corresponds to a false positive. Even in the case where the predictor outputs and/or the specific risk score is deemed (e.g., by the administrator) not to be a false positive, then rather than halting progression of the e-sign process, instead increasing observance of potentially incriminating events that can later be used in forensic analysis and/or as evidence in a legal action.

The foregoing discussion of FIG. 5B pertains to merely some possible embodiments and/or ways to implement rule triggering. In some embodiments, rule triggering can be enhanced by integrating multiple systems with each other (e.g., by implementing an overarching security system, where data from such a security system can be used to define a system state). One example of an overarching security system is shown and described as pertains to the alternative system embodiments discussed hereunder. Alternatively or additionally, the foregoing embodiments can be enhanced by implementing a graph data repository (where data from a graph data repository can be used to define a system state). One example of a graph data repository is shown and described as pertains to the alternative system embodiments discussed hereunder.

### Alternative System Embodiments

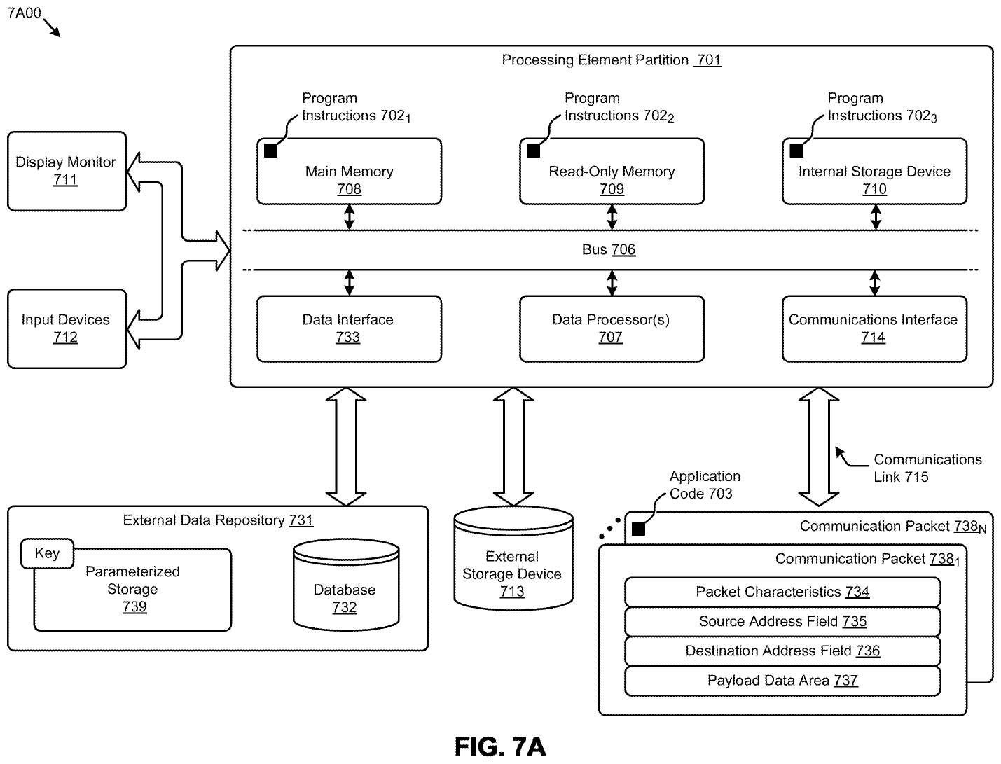

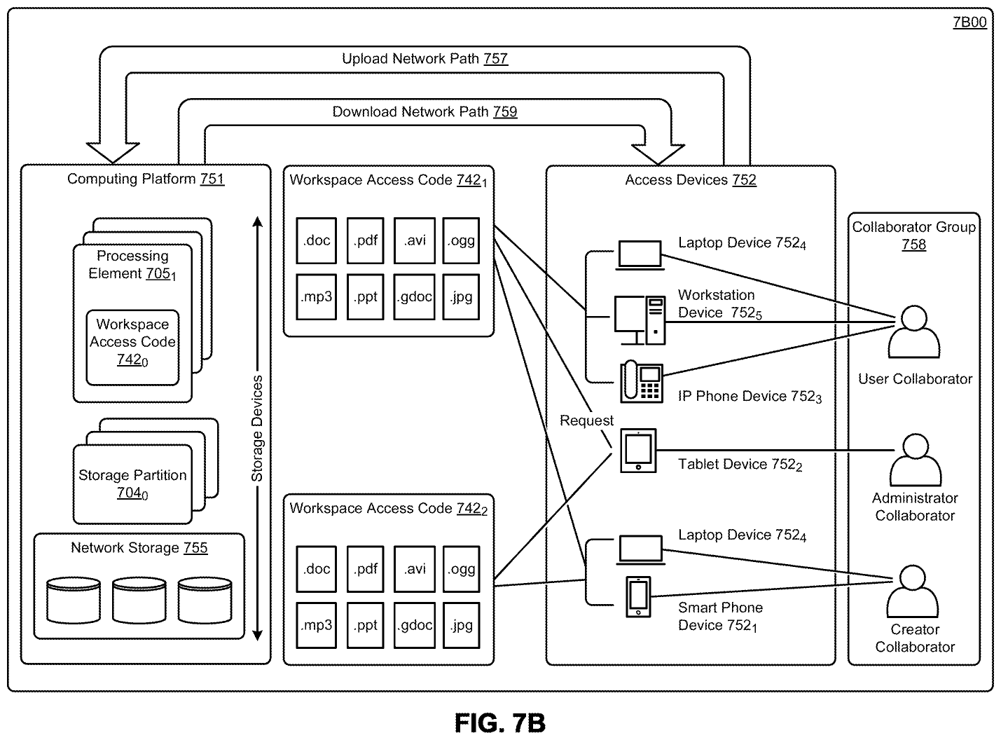

FIG. 6A depicts an example multisystem integration technique that is configured for real-time identification of suspicious activities during e-sign processing. As an option, one or more variations of multisystem integration technique 6A00 or any aspect thereof may be implemented in the context of the architecture and functionality of the embodiments described herein and/or in any environment.

The figure is being presented to illustrate how a security system can be integrated with (e.g., overlaid on top of) the combination of the CMS and the ESS. In the shown example, security system 602 is integrated with both the CMS and the ESS in a manner such that any information of the CMS and/or the ESS can be comprehended by the security system. Moreover, such a security system can output its own, independent assessment of risk (e.g., via the shown independent risk score 634), and such an independent assessment of risk can be provided to downstream processing 610, which might serve one possible mechanism for providing early warnings or alerts and/or for carrying out risk mitigation operations. In some situations a security system relies on particular sorts of data representation and associations. Such data representation and associations can be codified into highly-enriched graph data (e.g., data that constitutes a collaboration network graph). One example of such highly-enriched graph data is shown and described as pertains to FIG. 6B.

FIG. 6B depicts an example organization of highly-enriched graph data. The highly-enriched graph data can be used to form a highly-enriched collaboration network graph, which in turn can be used to facilitate formation of, and/or access to, the foregoing historical record of collaborator events. As an option, one or more variations of representative data structures 6B00 or any aspect thereof may be implemented in the context of the architecture and functionality of the embodiments described herein. The representative data structures 6B00 or any aspect thereof may be implemented in any environment.

FIG. 6B is being presented to illustrate one embodiment of data structures that can be implemented to organize certain data used when implementing the herein disclosed techniques. The figure further illustrates a logical depiction of data flows of such data in an example scenario as performed in accordance with the herein disclosed techniques.

The data sets described herein can be organized and/or stored using various techniques. Specifically, the data structures corresponding to the data sets shown in FIG. 6B are designed to improve the way a computer stores and retrieves data in memory when performing steps and/or operations pertaining to on-demand generation of collaboration networks. For example, the data comprising event objects 622 might be organized and/or stored in a tabular structure (e.g., relational database table) that has rows that relate various attributes, such as source and target entity identifiers, that pertain to a particular entity interaction event. As another example, the information might be organized and/or stored in a programming code object that has instances corresponding to a particular entity interaction event and properties corresponding to the various attributes associated with the event.

As depicted by a set of select event object attributes 662, an entity interaction event data record (e.g., table row or object instance) for a particular entity interaction event might describe a source (or first) entity identifier (e.g., stored in a “sourceID” field), a target (or second) entity identifier (e.g., stored in a “targetID” field), a description of the event or interaction type (e.g., stored in a “type” field), a weight associated with the event or interaction type (e.g., stored in a “weight” field), an event timestamp (e.g., stored in a “time” field), and/or other interaction attributes. As indicated by a representative update API call 672, an event object might be included (e.g., in an “<object>” argument list) in an HTTP call (e.g., a POST) that identifies a particular graph (e.g., specified by a “graphID” field) and source and target entity assignment (e.g., specified by a “source” field and a “target” field) over which to apply the event object. An example event object is shown in Table 2.

TABLE 2
Example event object

| Line | Content |
|---|---|
| 1 | [ |
| 2 | { |
| 3 | “source”: “enterprise1”, |
| 4 | “target”: “location1”, |
| 5 | “weight”: 1, |
| 6 | “time”: 1537298532000 |
| 7 | } |
| 8 | ] |

As an example of another data structure implementation, configuration documents 640 might comprise various configuration files that in turn comprise graph definitions 642, feed definitions 644, entity relationship scoring techniques 658, and/or other information. To achieve the reduction or elimination of the specialized coding effort associated with introducing new collaboration insights as facilitated by the herein disclosed techniques, such configuration files might merely comprise uncompiled structured text. For example, the information in the configuration files might comprise parameters and parameter values codified as text-based key-value pairs (e.g., “key=value”).

As another example, certain attributes might be marked (e.g., for parsing) in the configuration files by certain tags or characters (e.g., “[attribute]”). Specifically, a feed config file structure 652 indicates a corresponding configuration file in configuration documents 640 that might include certain information associated with each instance of feed definitions 644, such as a feed definition identifier (e.g., associated with a “feedID” key), one or more feed parameters (e.g., associated with a “params[ ]” object), one or more graph definitions (e.g., associated with a “graphs[ ]” object), and/or other feed definition information. As can be observed, the “graphs[ ]” object might include a graph definition identifier (e.g., associated with a “graphID” key) for each graph definition referenced by a feed definition. An example feed definition is shown in Table 3.

TABLE 3
Example feed definition

| Line | Content |
|---|---|
| 1 | [news -feed] |
| 2 | graph=recent-action-events |
| 3 | minUsers=100 |
| 4 | maxFilesPerUser=100 |
| 5 | maxEvents=10 |
| 6 | sortByScore=true |
| 7 | mostRecentEvent=false |

Each “graphID” attribute included in feed definitions 644 references a particular instance of graph definitions 642 as described in one or more configuration files. Specifically, a graph config file structure 654 indicates a corresponding configuration file in configuration documents 640 that might include certain information associated with each instance of graph definitions 642, such as a graph definition identifier (e.g., associated with a “graphID” key), one or more entity relationship types (e.g., associated with a “relTypes[ ]” object), one or more entity relationship scoring techniques (e.g., associated with a “specs[ ]” object), and/or other graph definition information. As indicated, the “relTypes[ ]” object might describe one or more pairs of source and target entity types (e.g., stored as a “source: target” pair). Furthermore, the “specs[ ]” object might describe a scoring technique identifier (e.g., associated with a “specID” key) for each scoring technique referenced by a graph definition. An example graph definition is shown in Table 4.

TABLE 4
Example graph definition

| Line | Content |
|---|---|
| 1 | [recent-action-events] |
| 2 | relTypes=user:file,user:comment,file:modify,... |
| 3 | spec=overwrite |
| 4 | spec.bidirectional=false |

Each “specID” attribute included in graph definitions 642 references a particular instance of an entity relationship scoring technique described in one or more configuration files in configuration documents 640. Specifically, a spec config file structure 656 indicates a corresponding configuration file in configuration documents 640 that might include certain information associated with each instance of entity relationship scoring techniques 658, such as a technique identifier (e.g., associated with a “specID” key), one or more parameters associated with the technique (e.g., associated with a “parameters[ ]” object), and/or other entity relationship scoring technique information. Example entity relationship scoring technique descriptions are shown in Table 5.

TABLE 5
Example entity relationship scoring technique definitions

| Line | Content |
|---|---|
| 1 | [overwrite] |
| 2 | bidirectional=false |
| 3 | [backward-time-decay] |
| 4 | maxDaysToDecay=31 |
| 5 | maxScore=10000000 |
| 6 | maxTimeToDedupeMs=360000 |
| 7 | limitMultiplier=1.5 |

As illustrated in FIG. 6B, event objects 622, entity attributes 648, and at least a portion of the information associated with configuration documents 640 are accessed to form various instances of graph data 633. A set of select collaboration network graph attributes 668 indicate that data records (e.g., table rows or object instances) associated with a particular collaboration network graph might describe various attributes corresponding to the pairwise entity relationships comprising the graphs. Specifically, the data records might describe a graph identifier (e.g., stored in a “graphID” field), a source (or first) entity identifier (e.g., stored in a “source ID” field), a target (or second) entity identifier (e.g., stored in a “targetID” field), one or more score components associated with entity relationships between the source entity and the target entity (e.g., stored in a “score[ ]” object), one or more details pertaining to the entities and/or the entity relationship of the pair (e.g., stored in a “details[ ]” object), and/or other attributes of the pairwise entity relationship.

In response to instances of feed requests 624 applied over the collaboration network graphs stored in graph data 633, respective instances of feed objects 618 are produced. As indicated by a representative request API call 674, a feed request might be issued as an HTTP call (e.g., GET call) that specifies various instances of request attributes 664 in the call. As can be observed in representative request API call 674, such request attributes might include a particular feed definition (e.g., specified by a “feedID” field), an entity type (e.g., specified by an “entity” field), an entity identifier (e.g., specified by an “entityID” field), and one or more entity attributes or details to return in the response (e.g., specified in an “<attr>” argument list). The feed objects returned in response to a particular feed request are often entity-specific (e.g., for the entity identified by “entityID”).

A set of select feed object attributes 666 indicate that each feed object instance produced in response to a feed request might comprise an entity identifier for a subject entity (e.g., stored in an “entityID” field), a description of the entity type for the subject entity (e.g., stored in a “type” field), a score associated with the feed object (e.g., stored in a “score” field), a timestamp associated with the feed object and/or an underlying event (e.g., stored in a “time” field), one or more details (e.g., entity attributes) associated with the subject entity (e.g., stored in a “details[ ]” object), and/or other feed object attributes. An example feed object is shown in Table 6.

TABLE 6
Example feed object

| Line | Content |
|---|---|
| 1 | [ |
| 2 | { |
| 3 | entityID: “5745857184”, |
| 4 | type: “file”, |
| 5 | score: 0.0000982734509874, |
| 6 | time: 1536627039000, |
| 7 | details: [ |
| 8 | { |
| 9 | owner: true, |
| 10 | roleIDs: [ ], |
| 11 | type: “AccessLevel” |
| 12 | } |
| 13 | ] |
| 14 | } |
| 15 | ] |

Further details regarding techniques for making and using a collaboration network graph can be found in U.S. patent application Ser. No. 16/154,679 titled “ON-DEMAND COLLABORATION USER INTERFACES” filed on Oct. 8, 2018, which is hereby incorporated by reference in its entirety.

### System Architecture Overview

### Additional System Architecture Examples

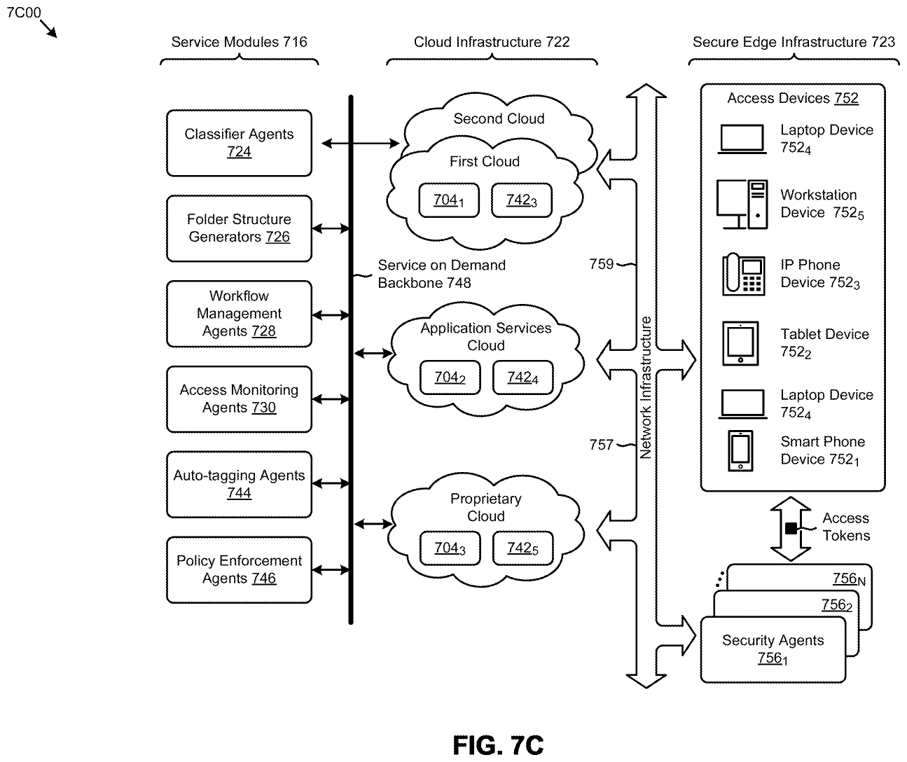

FIG. 7A depicts a block diagram of an instance of computer system 7A00 suitable for implementing embodiments of the present disclosure. Computer system 7A00 includes a bus 706 or other communication mechanism for communicating information. The bus interconnects subsystems and devices such as a central processing unit (CPU), or a multi-core CPU (e.g., data processor 707), a system memory (e.g., main memory 708, or an area of random access memory (RAM)), a non-volatile storage device or non-volatile storage area (e.g., read-only memory 709), an internal storage device 710 or external storage device 713 (e.g., magnetic or optical), a data interface 733, a communications interface 714 (e.g., PHY, MAC, Ethernet interface, modem, etc.). The aforementioned components are shown within processing element partition 701, however other partitions are possible. Computer system 7A00 further comprises a display 711 (e.g., CRT or LCD), various input devices 712 (e.g., keyboard, cursor control), and an external data repository 731.

According to an embodiment of the disclosure, computer system 7A00 performs specific operations by data processor 707 executing one or more sequences of one or more program instructions contained in a memory. Such instructions (e.g., program instructions 702₁, program instructions 702₂, program instructions 702₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 7A00 performs specific networking operations using one or more instances of communications interface 714. Instances of communications interface 714 may comprise one or more networking ports that are configurable (e.g., pertaining to speed, protocol, physical layer characteristics, media access characteristics, etc.) and any particular instance of communications interface 714 or port thereto can be configured differently from any other particular instance. Portions of a communication protocol can be carried out in whole or in part by any instance of communications interface 714, and data (e.g., packets, data structures, bit fields, etc.) can be positioned in storage locations within communications interface 714, or within system memory, and such data can be accessed (e.g., using random access addressing, or using direct memory access DMA, etc.) by devices such as data processor 707.

Communications link 715 can be configured to transmit (e.g., send, receive, signal, etc.) any types of communications packets (e.g., communication packet 738₁, communication packet 738_{N}) comprising any organization of data items. The data items can comprise a payload data area 737, a destination address 736 (e.g., a destination IP address), a source address 735 (e.g., a source IP address), and can include various encodings or formatting of bit fields to populate packet characteristics 734. In some cases, the packet characteristics include a version identifier, a packet or payload length, a traffic class, a flow label, etc. In some cases, payload data area 737 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 707 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 731, which in turn can be formatted into any one or more storage areas, and which can comprise parameterized storage 739 accessible by a key (e.g., filename, table name, block address, offset address, etc.).

Execution of the sequences of instructions to practice certain embodiments of the disclosure are performed by a single instance of computer system 7A00. According to certain embodiments of the disclosure, two or more instances of computer system 7A00 coupled by a communications link 715 (e.g., LAN, public switched telephone network, or wireless network) may perform the sequence of instructions required to practice embodiments of the disclosure using two or more instances of components of computer system 7A00.

Computer system 7A00 may transmit and receive messages such as data and/or instructions organized into a data structure (e.g., communications packets). The data structure can include program instructions (e.g., application code 703), communicated through communications link 715 and communications interface 714. Received program instructions may be executed by data processor 707 as it is received and/or stored in the shown storage device or in or upon any other non-volatile storage for later execution. Computer system 7A00 may communicate through a data interface 733 to a database 732 on an external data repository 731. Data items in a database can be accessed using a primary key (e.g., a relational database primary key).

Processing element partition 701 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 707. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to defining a security perimeter based on content management system observations of user behavior. A module may include one or more state machines and/or combinational logic used to implement or facilitate the operational and/or performance characteristics pertaining to/or real-time identification of suspicious activities during e-sign processing.

Various implementations of database 732 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of real-time identification of suspicious activities during e-sign processing). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to real-time identification of suspicious activities during e-sign processing, and/or for improving the way data is manipulated when performing computerized operations pertaining to continuously updating content object-specific risk assessments.

FIG. 7B depicts a block diagram of an instance of cloud-based environment 7B00. Such a cloud-based environment supports access to workspaces through the execution of workspace access code (e.g., workspace access code 742₀, workspace access code 742₁, and workspace access code 742₂). Workspace access code can be executed on any of access devices 752 (e.g., laptop device 752₄, workstation device 752₅, IP phone device 752₃, tablet device 752₂, smart phone device 752₁, etc.), and can be configured to access any type of object. Strictly as examples, such objects can be folders or directories or can be files of any filetype. The files or folders or directories can be organized into any hierarchy. Any type of object can comprise or be associated with access permissions. The access permissions in turn may correspond to different actions to be taken over the object. Strictly as one example, a first permission (e.g., PREVIEW_ONLY) may be associated with a first action (e.g., preview), while a second permission (e.g., READ) may be associated with a second action (e.g., download), etc. Furthermore, permissions may be associated to or with any specific user or any particular group of users.

A group of users can form a collaborator group 758, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 751, including in a middleware setting. As shown, a portion of the workspace access code resides in and can be executed on one or more processing elements (e.g., processing element 705₁). The workspace access code can interface with storage devices such as networked storage 755. Storage of workspaces and/or any constituent files or objects, and/or any other code or scripts or data can be stored in any one or more storage partitions (e.g., storage partition 704₀). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 757). A stored workspace can be delivered to a specific user and/or shared with other specific users via a download (e.g., a download from a processing element to an access device over a download network path 759).

FIG. 7C depicts a block diagram of an instance of cloud-based computing system 7C00 suitable for implementing embodiments of the present disclosure. More particularly, the cloud-based computing system is suitable for implementing a cloud content management system, which cloud-based computing system is sometimes known as a cloud content manager (CCM).

The figure shows multiple variations of cloud implementations that embody or support a CCM. Specifically, public clouds (e.g., a first cloud and a second cloud) are intermixed with non-public clouds (e.g., the shown application services cloud and a proprietary cloud). Any and/or all of the clouds can support cloud-based storage (e.g., storage partition 704₁, storage partition 704₂, storage partition 704₃) as well as access device interface code (workspace code 742₃, workspace code 742₄, workspace code 742₅).

The clouds are interfaced to network infrastructure, which provides connectivity between any/all of the clouds and any/all of the access devices 752. More particularly, any constituents of the cloud infrastructure 722 can interface with any constituents of the secure edge infrastructure 723 (e.g., by communicating over the network infrastructure). The aforementioned access devices can communicate over the network infrastructure to access any forms of identity and access management tools (IAMs) which in turn can implement or interface to one or more security agents (e.g., security agents 756₁, security agents 756₂, . . . , security agents 756_{N}). Such security agents are configured to produce access tokens, which in turn provide authentication of users and/or authentication of corresponding user devices, as well as to provide access controls (e.g., allow or deny) corresponding to various types of requests by devices of the secure edge infrastructure.

As shown, the cloud infrastructure is also interfaced for access to service modules 716. The various service modules can be accessed over the shown service on demand backbone 748 using any known technique and for any purpose (e.g., for downloading and/or for application programming interfacing and/or for local or remote execution). The service modules can be partitioned in any manner. The partitioning shown (e.g., into modules labeled as classifier agents 724, folder structure generators 726, workflow management agents 728, access monitoring agents 730, auto-tagging agents 744, and policy enforcement agents 746) is presented merely for illustrative purposes and many other service modules can be made accessible to the cloud infrastructure. Some of the possible service modules are discussed hereunder.

Classifier agents serve to automatically classify (and find) files by defining and associating metadata fields with content objects, and then indexing the results of that classification. In some cases a classifier agent processes one or more content objects for easy retrieval (e.g., via bookmarking).

Folder structure generators relieve users from having to concoct names and hierarchies for folder structures. Rather, names and hierarchies of folder structures are automatically generated based on the actual information in the content objects and/or based on sharing parameters and/or based on events.

Workflow management agents provide automation to deal with repeatable tasks and are configured to create workflow triggers that in turn invoke workflows at particularly-configured entry points. Triggers can be based on any content and/or based on any observable events. Strictly as examples, triggers can be based on events such as, content reviews, employee onboarding, contract approvals, and so on.

Access monitoring agents observe and keep track of use events such as file previews, user uploads and downloads, etc. In some embodiments, access monitoring agents are interfaced with presentation tools so as to present easy-to-understand visuals (e.g., computer-generated graphical depictions of observed user events).

Auto-tagging agents analyze combinations of content objects and events pertaining to those content objects such that the analyzed content objects can be automatically tagged with highly informative metadata and/or automatically stored in appropriate locations. In some embodiments, one or more auto-tagging agents operate in conjunction with folder structure generators so as to automatically analyze, tag and organize content (e.g., unstructured content). Generated metadata is loaded into a content object index to facilitate near instant retrieval of sought after content objects and/or their containing folders.

Policy enforcement agents run continuously (e.g., in the background) so as to aid in enforcing security and compliance policies. Certain policy enforcement agents are configured to deal with items such as content object retention schedules, achievement of time-oriented governance requirements, and establishment and maintenance of trust controls (e.g., smart access control exceptions). Further, certain policy enforcement agents apply machine learning techniques to deal with items such as dynamic threat detection.

The CCM, either by operation of individual constituents and/or as a whole, facilitates collaboration with third parties (e.g., agencies, vendors, external collaborators, etc.) while maintaining sensitive materials in one secure place. The CCM implements cradle-to-grave controls that result in automatic generation and high availability of high-quality content through any number of collaboration cycles (e.g., from draft to final to disposal, etc.) while constantly enforcing access and governance controls.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method comprising:
identifying a content management system (CMS) wherein collaboration activities occur over time and over a content object maintained in the CMS, and wherein the CMS maintains a historical record of collaborator activities over the content object;
identifying an electronic signature system (ESS) that facilitates an e-signing event at the electronic signature system;
performing an analysis of the e-signing event using both (a) the historical record of collaborator activities for the content object at the CMS and (b) information from an interaction with the ESS; and
emitting an alert or initiating one or more recommended remediation actions.

2. The method of claim 1, further comprising initiating the one or more recommended remediation actions only when a risk score or a likelihood value breaches a threshold.

3. The method of claim 1, wherein a first machine learning model outputs a risk score or likelihood value that indicates at least potentially suspicious activities, and wherein a second machine learning model outputs the one or more recommended remediation actions.

4. The method of claim 1, wherein at least a portion of first events of the content management system is codified as first signal inputs of the predictive model, and wherein at least a portion of second events initiated by at least one user of the electronic signature system is codified as second signal inputs to a predictive model.

5. The method of claim 1, wherein one or more remediation activities are recommended based on a risk scoring function or a risk score or a likelihood value.

6. The method of claim 5, wherein the risk scoring function comprises at least a similarity of a set of current events to a set of historical events.

7. The method of claim 6, further comprising performing a statistical anomaly analysis over a user's historical activity.

8. The method of claim 1, wherein the analysis of the e-signing event identifies at least one of, an IP address anomaly, an access pattern anomaly, or a timing pattern anomaly.

9. The method of claim 1, wherein the historical record of collaborator activities is stored, at least in part as a collaboration network graph.

10. A non-transitory computer readable medium having stored thereon a sequence of instructions which, when stored in memory and executed by one or more processors causes the one or more processors to perform a set of acts, the set of acts comprising:
identifying a content management system (CMS) wherein collaboration activities occur over time and over a content object maintained in the CMS, and wherein the CMS maintains a historical record of collaborator activities over the content object;
identifying an electronic signature system (ESS) that facilitates an e-signing event at the electronic signature system;
performing an analysis of the e-signing event using both (a) the historical record of collaborator activities for the content object at the CMS and (b) information from an interaction with the ESS; and
emitting an alert or initiating one or more recommended remediation actions.

11. The non-transitory computer readable medium of claim 10, further comprising instructions which, when stored in memory and executed by the one or more processors causes the one or more processors to perform acts of initiating the one or more recommended remediation actions only when a risk score or a likelihood value breaches a threshold.

12. The non-transitory computer readable medium of claim 10, wherein a first machine learning model outputs a risk score or likelihood value that indicates at least potentially suspicious activities, and wherein a second machine learning model outputs the one or more recommended remediation actions.

13. The non-transitory computer readable medium of claim 10, wherein at least a portion of first events of the content management system is codified as first signal inputs of the predictive model, and wherein at least a portion of second events initiated by at least one user of the electronic signature system is codified as second signal inputs to a predictive model.

14. The non-transitory computer readable medium of claim 10, wherein one or more remediation activities are recommended based on a risk scoring function or a risk score or a likelihood value.

15. The non-transitory computer readable medium of claim 14, wherein the risk scoring function comprises at least a similarity of a set of current events to a set of historical events.

16. The non-transitory computer readable medium of claim 15, further comprising instructions which, when stored in memory and executed by the one or more processors causes the one or more processors to perform acts of performing a statistical anomaly analysis over a user's historical activity.

17. The non-transitory computer readable medium of claim 10, wherein the analysis of the e-signing event identifies at least one of, an IP address anomaly, an access pattern anomaly, or a timing pattern anomaly.

18. The non-transitory computer readable medium of claim 10, wherein the historical record of collaborator activities is stored, at least in part as a collaboration network graph.

19. A system comprising:
a storage medium having stored thereon a sequence of instructions; and
one or more processors that execute the sequence of instructions to cause the one or more processors to perform a set of acts, the set of acts comprising,
identifying a content management system (CMS) wherein collaboration activities occur over time and over a content object maintained in the CMS, and wherein the CMS maintains a historical record of collaborator activities over the content object;
identifying an electronic signature system (ESS) that facilitates an e-signing event at the electronic signature system;
performing an analysis of the e-signing event using both (a) the historical record of collaborator activities for the content object at the CMS and (b) information from an interaction with the ESS; and
emitting an alert or initiating one or more recommended remediation actions.

20. The system of claim 19, further comprising initiating the one or more recommended remediation actions only when a risk score or a likelihood value breaches a threshold.
